(19) United States
(12) Patent Application Publication
(10) Pub. No.: US 2014/0066551 A1
(43) Pub. Date: Mar. 6, 2014

(54) GLASS-FILLED POLYAMIDE COMPOSITION AND ARTICLE

(71) Applicant: SABIC INNOVATIVE PLASTICS IP B.V., Bergen op Zoom (NL)

(72) Inventors: Snezana Grcev, Bergen op Zoom (NL); Hans Fortuijn, Bergen op Zoom (NL)

(21) Appl. No.: 13/799,397

(22) Filed: Mar. 13, 2013

Related U.S. Application Data
(63) Continuation-in-part of application No. 13/598,689, filed on Aug. 30, 2012, now abandoned.

(51) Int. Cl. H01B 3/47

(52) U.S. Cl. CPC H01B 3/47
USPC 524/100

(57) ABSTRACT

A composition useful for molding electrical components is prepared by melt blending specific amounts of components including a polyamide, a poly(phenylene ether)-polysiloxane block copolymer reaction product including a poly(phenylene ether) and a poly(phenylene ether)-polysiloxane block copolymer, a flame retardant including a metal dialkylphosphinate, melamine polyphosphate, and zinc borate, and glass fibers. The use of a poly(phenylene ether)-polysiloxane block copolymer reaction product rather than a poly(phenylene ether) alone provides improved surface resistivity without sacrificing flame retardancy.

### CROSS REFERENCE TO RELATED APPLICATIONS

This application is a continuation-in-part of U.S. Nonprovisional patent application Ser. No. 13/598,689, filed 30 Aug. 2012, the contents of which are incorporated herein by reference in their entirety.

### BACKGROUND OF THE INVENTION

Poly(phenylene ether) resins have been blended with polyamide resins to provide compositions having beneficial properties including heat resistance, chemical resistance, impact strength, hydrolytic stability, and dimensional stability. A relatively new use of polyamide-poly(phenylene ether) blends is the molding of parts for electrical components, such parts including photovoltaic junction boxes and connectors, inverter housings, automotive electrical connectors, electrical relays, and charge couplers. These molded parts need to comply with stringent industry standards for flammability and electrical resistivity, while at the same time maintaining good mechanical properties. The use of flame retardant additives is needed to meet the flame retardancy requirements. However, polyamide-poly(phenylene ether) blends incorporating a preferred class of flame retardant additives, metal dialkylphosphinates, can be deficient in the surface resistivity property, Comparative Tracking Index (CTI). There remains a need for molding compositions that can exhibit improvements in CTI while maintaining high flame retardancy.

### BRIEF SUMMARY OF EMBODIMENTS OF THE INVENTION

One embodiment is a composition comprising the product of melt blending: 30 to 89 weight percent of a polyamide; 1 to 15 weight percent of a poly(phenylene ether)-polysiloxane block copolymer reaction product comprising a poly(phenylene ether) and a poly(phenylene ether)-polysiloxane block copolymer; 5 to 25 weight percent of a flame retardant comprising 4 to 16 weight percent of a metal dialkylphosphinate, 0.9 to 8 weight percent of melamine polyphosphate, and 0.1 to 3 weight percent of zinc borate; 5 to 45 weight percent of glass fibers; and 0 to 15 weight percent of a surface-treated Boehmite; wherein the composition comprises 5 to 20 weight percent of the flame retardant when the composition comprises 5 to 15 weight percent of the surface-treated Boehmite; wherein the composition comprises greater than 10 to 25 weight percent of the flame retardant when the composition comprises 0 to less than 5 weight percent of the surface-treated Boehmite; and wherein all weight percents are based on the total weight of the composition.

Another embodiment is an article comprising composition.

These and other embodiments are described in detail below.

### DETAILED DESCRIPTION OF THE INVENTION

The present inventors have determined that improvements in Comparative Tracking Index are observed when a poly(phenylene ether)-polysiloxane block copolymer reaction product, rather than poly(phenylene ether) alone, is incorporated into a polyamide composition containing metal dialkylphosphinate flame retardant. The improvement in CTI is obtained without sacrificing the highly desirable V-0 flammability rating of the Underwriter's Laboratory Bulletin 94 “Tests for Flammability of Plastic Materials, UL 94”, 20 mm Vertical Burning Flame Test. In some embodiments, the composition exhibits a comparative tracking index of at least 475 volts, specifically 475 to 600 volts, measured according to IEC-60112, Third edition, as well as a V-0 rating in the UL 94 flammability test.

Additional improvements in the balance of flame retardancy, electrical resistance, and melt flow are observed when an optional surface-treated Boehmite is added to the composition. In some embodiments in which the composition comprises the surface-treated Boehmite, the composition exhibits a melt viscosity less than or equal to 160 Pascal-seconds, specifically 120 to 160 Pascal-seconds, more specifically 125 to 155 Pascal-seconds, measured according to ISO 11443:2005 at 282° C. and a shear rate of 1,500 second⁻¹; a comparative tracking index of at least 525 volts, specifically 525 to 600 volts, more specifically 550 to 575 volts, measured according to IEC-60112, Third edition; and a 20 millimeter Vertical Burning Test rating of V-1 or V-0, specifically V-0, measured according to Underwriters Laboratory UL 94 “Tests for Flammability of Plastic Materials for Parts in Devices and Appliances”.

Thus, one embodiment is a composition comprising the product of melt blending: 30 to 89 weight percent of a polyamide; 1 to 15 weight percent of a poly(phenylene ether)-polysiloxane block copolymer reaction product comprising a poly(phenylene ether) and a poly(phenylene ether)-polysiloxane block copolymer; 5 to 25 weight percent of a flame retardant comprising 4 to 16 weight percent of a metal dialkylphosphinate, 0.9 to 8 weight percent of melamine polyphosphate, and 0.1 to 3 weight percent of zinc borate; 5 to 45 weight percent of glass fibers; and 0 to 15 weight percent of a surface-treated Boehmite; wherein the composition comprises 5 to 20 weight percent of the flame retardant when the composition comprises 5 to 15 weight percent of the surface-treated Boehmite; wherein the composition comprises greater than 10 to 25 weight percent of the flame retardant when the composition comprises 0 to less than 5 weight percent of the surface-treated Boehmite; and wherein all weight percents are based on the total weight of the composition.

The components melt blended to form the composition include a polyamide. In some embodiments, the polyamide is selected from the group consisting of polyamide-6, polyamide-6,6, polyamide-4,6, polyamide-11, polyamide-12, polyamide-6,10, polyamide-6,12, polyamide 6/6,6, polyamide-6/6,12, polyamide MXD,6 (where MXD is m-xylylene diamine), polyamide-6,T, polyamide-6,I, polyamide-6/6,T, polyamide-6/6,I, polyamide-6,6/6,T, polyamide-6,6/6,I, polyamide-6/6,T/6,I, polyamide-6,6/6,T/6,I, polyamide-6/12/6,T, polyamide-6,6/12/6,T, polyamide-6/12/6,I, polyamide-6,6/12/6,I, and combinations thereof. In some embodiments, the polyamide comprises polyamide-6, polyamide-6,6, or a combination thereof. In some embodiments, the polyamide comprises polyamide-6. In some embodiments, the polyamide is polyamide-6,6. In some embodiments, the polyamide is a combination of polyamide-6 and polyamide-6,6.

In some embodiments, the polyamide has a relative viscosity of 100 to 150 measured at 23° C. according to ASTM D789-07 in 90% formic acid, and an amine end group concentration of less than or equal to 100 microequivalents per gram. In some embodiments, the polyamide has an amine end group concentration of less than 100 microequivalents amine end group per gram of polyamide as determined by titration with hydrochloric acid. The amine end group concentration can be 20 to 100 microequivalents per gram, specifically 30 to 80 microequivalents per gram, more specifically 40 to 70 microequivalents per gram Amine end group content can be determined by dissolving the polyamide in a suitable solvent and titrating with 0.01 Normal hydrochloric acid (HCl) solution using a suitable indication method. The amount of amine end groups is calculated based the volume of HCl solution added to the sample, the volume of HCl used for the blank, the molarity of the HCl solution, and the weight of the polyamide sample. Methods for the preparation of polyamides are known, and many polyamides are commercially available.

The polyamide is used in an amount of 30 to 89 weight percent, based on the total weight of the composition (which is equivalent to the total weight of melt blended components). Within this range, the polyamide amount can be 30 to 79 weight percent, specifically 40 to 70 weight percent. In some embodiments, including some embodiments in which the composition comprises less than 5 weight percent, specifically less than 2 weight percent of the surface-treated Boehmite, the composition comprises the polyamide in an amount of 40 to 60 weight percent, specifically 43 to 55 weight percent, more specifically 44 to 52 weight percent, based on the total weight of the composition. In other embodiments, including some embodiments in which the composition comprises 2 to 15 weight percent, specifically 5 to 15 weight percent of the surface-treated Boehmite, the composition comprises the polyamide in an amount of 30 to 74.8 weight percent, specifically 35 to 65 weight percent, more specifically 40 to 58 weight percent, still more specifically 40 to 53 weight percent, based on the total weight of the composition.

In addition to the polyamide, the components melt blended to form the composition include a poly(phenylene ether)-polysiloxane block copolymer reaction product comprising a poly(phenylene ether) and a poly(phenylene ether)-polysiloxane block copolymer. For brevity, the poly(phenylene ether)-polysiloxane block copolymer reaction product is sometimes referred to herein as the “reaction product”. The poly(phenylene ether)-polysiloxane block copolymer reaction product is synthesized by oxidative polymerization of a mixture of monohydric phenol and hydroxyaryl-terminated polysiloxane. This oxidative polymerization produces poly(phenylene ether)-polysiloxane block copolymer as the desired product and poly(phenylene ether) homopolymer (if a single monohydric phenol is used) or poly(phenylene ether) copolymer (if two or more monohydric phenols are used) as a by-product. It is difficult and unnecessary to separate the poly(phenylene ether) from the poly(phenylene ether)-polysiloxane block copolymer. The poly(phenylene ether)-polysiloxane block copolymer is therefore incorporated into the present composition as a “poly(phenylene ether)-polysiloxane block copolymer reaction product” that comprises both the poly(phenylene ether) and the poly(phenylene ether)-polysiloxane block copolymer.

The poly(phenylene ether)-polysiloxane block copolymer comprises a poly(phenylene ether) block and a polysiloxane block. The poly(phenylene ether) block is a residue of the polymerization of the monohydric phenol. In some embodiments, the poly(phenylene ether) block comprises phenylene ether repeating units having the structure

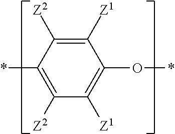

wherein for each repeating unit, each Z¹ is independently halogen, unsubstituted or substituted C₁-C₁₂, hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atom. In some embodiments, the poly(phenylene ether) block comprises 2,6-dimethyl-1,4-phenylene ether repeating units, that is, repeating units having the structure

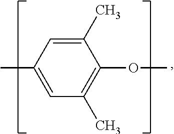

2,3,6-trimethyl-1,4-phenylene ether repeating units, or a combination thereof.

The polysiloxane block is a residue of the hydroxyaryl-terminated polysiloxane. In some embodiments, the polysiloxane block comprises repeating units having the structure

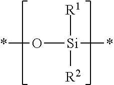

wherein each occurrence of R¹ and R² is independently hydrogen, C₁-C₁₂ hydrocarbyl or C₁-C₁₂, halohydrocarbyl; and the polysiloxane block further comprises a terminal unit having the structure

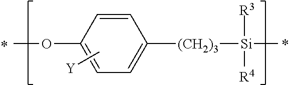

wherein Y is hydrogen, C₁-C₁₂ hydrocarbyl, C₁-C₁₂ hydrocarbyloxy, or halogen, and wherein each occurrence of R³ and R⁴ is independently hydrogen, C₁-C₁₂, hydrocarbyl or C₁-C₁₂ halohydrocarbyl. In some embodiments, the polysiloxane repeating units comprise dimethylsiloxane (—Si(CH₃)₂O—) units. In some embodiments, the polysiloxane block has the structure

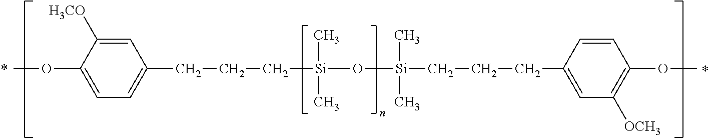

wherein n is, on average, 20 to 60.

The hydroxyaryl-terminated polysiloxane comprises at least one hydroxyaryl terminal group. In some embodiments, the hydroxyaryl-terminated polysiloxane has a single hydroxyaryl terminal group, in which case a poly(phenylene ether)-polysiloxane diblock copolymer is formed. In other embodiments, the hydroxyaryl-terminated polysiloxane has two hydroxyaryl terminal groups, in which case in which case poly(phenylene ether)-polysiloxane diblock copolymer and/or poly(phenylene ether)-polysiloxane-poly(phenylene ether) triblock copolymer are formed. It is also possible for the hydroxyaryl-terminated polysiloxane to have a branched structure that allows three or more hydroxyaryl terminal groups and the formation of corresponding branched block copolymers.

In some embodiments, the hydroxyaryl-terminated polysiloxane comprises, on average, 20 to 80 siloxane repeating units, specifically 25 to 70 siloxane repeating units, more specifically 30 to 60 siloxane repeating units, still more specifically 35 to 50 siloxane repeating units, yet more specifically 40 to 50 siloxane repeating units. The number of siloxane repeating units in the polysiloxane block is essentially unaffected by the copolymerization and isolation conditions, and it is therefore equivalent to the number of siloxane repeating units in the hydroxyaryl-terminated polysiloxane starting material. When not otherwise known, the average number of siloxane repeating units per hydroxyaryl-terminated polysiloxane molecule can be determined by nuclear magnetic resonance (NMR) methods that compare the intensities of signals associated with the siloxane repeating units to those associated with the hydroxyaryl terminal groups. For example, when the hydroxyaryl-terminated polysiloxane is a eugenol-capped polydimethylsiloxane, it is possible to determine the average number of siloxane repeating units by a proton nuclear magnetic resonance (¹H NMR) method in which integrals for the protons of the dimethylsiloxane resonance and the protons of the eugenol methoxy group are compared.

The poly(phenylene ether)-polysiloxane block copolymer comprises a poly(phenylene ether) block and a polysiloxane block, and in some embodiments, the composition comprises 0.2 to 1 weight percent, specifically 0.3 to 0.8 weight percent, of the polysiloxane block, based on the total weight of the composition.

In some embodiments, the poly(phenylene ether)-polysiloxane block copolymer reaction product has a weight average molecular weight of at least 30,000 atomic mass units. For example, the reaction product can have a weight average molecular weight of 30,000 to 150,000 atomic mass units, specifically 35,000 to 120,000 atomic mass units, more specifically 40,000 to 90,000 atomic mass units, even more specifically 45,000 to 70,000 atomic mass units. In some embodiments, the poly(phenylene ether)-polysiloxane block copolymer reaction product has a number average molecular weight of 10,000 to 50,000 atomic mass units, specifically 10,000 to 30,000 atomic mass units, more specifically 14,000 to 24,000 atomic mass units.

In some embodiments, the poly(phenylene ether)-polysiloxane block copolymer reaction product has an intrinsic viscosity of at least 0.3 deciliter per gram, as measured by Ubbelohde viscometer at 25° C. in chloroform. In some embodiments, the intrinsic viscosity is 0.3 to 0.5 deciliter per gram, specifically 0.31 to 0.5 deciliter per gram, more specifically 0.35 to 0.47 deciliter per gram.

One indication of the efficiency with which the hydroxyaryl-terminated polysiloxane is incorporated into block copolymer is the low concentration of so-called poly(phenylene ether) “tail” groups in the reaction product. In a homopolymerization of 2,6-dimethylphenol, a large fraction of product molecules have a so-called head-to-tail structure in which the linear product molecule is terminated on one end by a 3,5-dimethyl-4-hydroxyphenyl “head” and on the other end by a 2,6-dimethylphenoxy “tail”. Thus, when the monohydric phenol consists of 2,6-dimethylphenol, the poly(phenylene ether) tail group has the structure

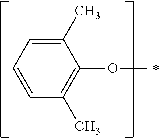

wherein the 3-, 4-, and 5-positions of the ring are substituted with hydrogen atoms (that is, the term “2,6-dimethylphenoxy” refers to a monovalent group and does not encompass divalent 2,6-dimethyl-1,4-phenylene ether groups). In a copolymerization of monohydric phenol with hydroxyaryl-terminated polysiloxane, incorporation of the hydroxyaryl-terminated polysiloxane into block copolymer will reduce the concentration of phenylene ether “tail” groups. Thus, in some embodiments, the monohydric phenol consists of 2,6-dimethylphenol, and the reaction product of comprises less than or equal to 0.4 weight percent, specifically 0.1 to 0.4 weight percent, of 2,6-dimethylphenoxy groups, based on the weight of the reaction product. The 2,6-dimethylphenoxy tail end groups are characteristic of poly(2,6-dimethyl-1,4-phenylene ether) homopolymer with a head-to-tail (hydroxy-monoterminated) structure in which the linear product molecule is terminated on one end by a 3,5-dimethyl-4-hydroxyphenyl “head” and on the other end by a 2,6-dimethylphenoxy “tail”. So, the low concentration of 2,6-dimethylphenoxy tail end groups is an indication that the reaction product comprises a reduced concentration of such monofunctional homopolymer and an increased concentration of the desired poly(phenylene ether)-polysiloxane block copolymer.

The poly(phenylene ether)-polysiloxane block copolymer reaction product can further include groups derived from a diphenoquinone, which is itself an oxidation product of the monohydric phenol. For example, when the monohydric phenol is 2,6-dimethylphenol, the diphenoquinone is 3,3′,5,5′-tetramethyl-4,4′-diphenoquinone. During the build phase of the copolymerization, the diphenoquinone is typically incorporated into the “tail” end of a head-to-tail poly(phenylene ether) as the corresponding biphenyl group. Through further reactions, the terminal biphenyl group can become an internal biphenyl group in the poly(phenylene ether) chain. In some embodiments, the monohydric phenol consists of 2,6-dimethylphenol, and the reaction product comprises 0.1 to 2.0 weight percent, and specifically 1.1 to 2.0 weight percent, of 2,6-dimethyl-4-(3,5-dimethyl-4-hydroxyphenyl)-phenoxy (“biphenyl”) groups. The biphenyl groups are present only in bifunctional (head-to-head or hydroxyl-diterminated) structure. So, the low concentration of biphenyl group is an indication that the reaction product comprises a reduced concentration of such bifunctional homopolymer and an increased concentration of the desired poly(phenylene ether)-polysiloxane block copolymer.

The oxidative copolymerization can be conducted with a reaction time greater than or equal to 110 minutes. The reaction time is the elapsed time between initiation and termination of oxygen flow. (Although, for brevity, the description herein repeatedly refers to “oxygen” or “oxygen flow”, it will be understood that any oxygen-containing gas, including air, can be used as the oxygen source.) In some embodiments, the reaction time is 110 to 300 minutes, specifically 140 to 250 minutes, more specifically 170 to 220 minutes.

The oxidative copolymerization can include a “build time”, which is the time between completion of monomer addition and termination of oxygen flow. In some embodiments, the reaction time comprises a build time of 80 to 160 minutes. In some embodiments, the reaction temperature during at least part of the build time can be 40 to 60° C., specifically 45 to 55° C.

The poly(phenylene ether)-polysiloxane block copolymer reaction product can be isolated from solution by an isolation procedure that minimizes volatile and nonvolatile contaminants. For example, in some embodiments, the reaction product comprises less than or equal to 1 weight percent of total volatiles, specifically 0.2 to 1 weight percent of total volatiles. In some embodiments, the monomer mixture is oxidatively copolymerized in the presence of a catalyst comprising a metal (such as copper or manganese), and the poly(phenylene ether)-polysiloxane block copolymer reaction product comprises less than or equal to 100 parts per million by weight of the metal, specifically 5 to 100 parts per million by weight of the metal, more specifically 10 to 50 parts per million by weight of the metal, even more specifically 20 to 50 parts per million by weight of the metal, based on the weight of the poly(phenylene ether)-polysiloxane block copolymer reaction product.

Certain isolation procedures make it possible to assure that the poly(phenylene ether)-polysiloxane block copolymer reaction product is essentially free of residual hydroxyaryl-terminated polysiloxane starting material. In other words, these isolation procedures assure that the polysiloxane content of the reaction product consists essentially of the polysiloxane blocks of poly(phenylene ether)-polysiloxane block copolymer. After termination of the copolymerization reaction, the poly(phenylene ether)-polysiloxane block copolymer reaction product can be isolated from solution using methods known in the art for isolating poly(phenylene ether)s from solution. For example, the poly(phenylene ether)-polysiloxane block copolymer reaction product can be isolated by precipitation with an antisolvent comprising at least 50 weight percent of one or more C₁-C₆ alkanols, such as methanol, ethanol, n-propanol, or isopropanol. The use of an isopropanol-containing antisolvent is advantageous because isopropanol is a good solvent for unreacted hydroxyaryl-terminated polysiloxane. Therefore, precipitation and/or washing with an isopropanol-containing antisolvent (e.g., isopropanol alone) substantially remove hydroxyaryl-terminated polysiloxane from the isolated product. Thus, in some embodiments the poly(phenylene ether)-polysiloxane block copolymer reaction product comprises less than or equal to 1.5 weight percent of the hydroxyaryl-terminated polysiloxane, specifically less than or equal to 1 weight percent of the hydroxyaryl-terminated polysiloxane, more specifically less than or equal to 0.5 weight percent of the hydroxyaryl-terminated polysiloxane, based on the total weight of the poly(phenylene ether)-polysiloxane block copolymer reaction product. In some embodiments, the composition comprises less than or equal to 20 parts by weight of hydroxyaryl-terminated polysiloxane not covalently bound in the poly(phenylene ether)-polysiloxane block copolymer for each 100 parts by weight of hydroxyaryl-terminated polysiloxane covalently bound in the poly(phenylene ether)-polysiloxane block copolymer. Within this limit, the amount of hydroxyaryl-terminated polysiloxane not covalently bound in the poly(phenylene ether)-polysiloxane block copolymer can be less than or equal to 10 parts by weight, specifically less than or equal to 5 parts by weight, more specifically less than or equal to 2 parts by weight, even more specifically less than or equal to 1 part by weight.

In some embodiments, the poly(phenylene ether)-polysiloxane block copolymer reaction product incorporates greater than 75 weight percent, of the hydroxyaryl-terminated polysiloxane starting material into the poly(phenylene ether)-polysiloxane block copolymer. Specifically, the amount of the hydroxyaryl-terminated polysiloxane incorporated into the poly(phenylene ether)-polysiloxane block copolymer can be at least 80 weight percent, more specifically at least 85 weight percent, still more specifically at least 90 weight percent, yet more specifically at least 95 weight percent.

Additional details relating to the preparation, characterization, and properties of the poly(phenylene ether)-polysiloxane block copolymer reaction product can be found in U.S. Pat. No. 8,017,697 to Carrillo et al., and in U.S. Patent Application Publication No. US 2012/0329961 A1 of Carrillo et al.

The poly(phenylene ether)-polysiloxane block copolymer reaction product comprises 1 to 30 weight percent siloxane repeating units and 70 to 99 weight percent phenylene ether repeating units, based on the total weight of the reaction product. It will be understood that the siloxane repeating units are derived from the hydroxyaryl-terminated polysiloxane, and the phenylene ether repeating units are derived from the monohydric phenol. In some embodiments, such as, for example, when the poly(phenylene ether)-polysiloxane block copolymer reaction product is purified via precipitation in isopropanol, the siloxane repeating units consist essentially of the residue of hydroxyaryl-terminated polysiloxane that has been incorporated into the poly(phenylene ether)-polysiloxane block copolymer.

In some embodiments, the reaction product comprises 1 to 8 weight percent siloxane repeating units and 12 to 99 weight percent phenylene ether repeating units, based on the total weight of the reaction product. Within these ranges, the amount of siloxane repeating units can be 2 to 7 weight percent, specifically 3 to 6 weight percent, more specifically 4 to 5 weight percent; and the amount of phenylene ether repeating units can be 93 to 98 weight percent, specifically 94 to 97 weight percent, more specifically 95 to 96 weight percent.

The reaction product can include relatively small amounts of very low molecular weight species. Thus, in some embodiments, the reaction product comprises less than 25 weight percent of molecules having a molecular weight less than 10,000 atomic mass units, specifically 5 to 25 weight percent of molecules having a molecular weight less than 10,000 atomic mass units, more specifically 7 to 21 weight percent of molecules having a molecular weight less than 10,000 atomic mass units. In some embodiments, the molecules having a molecular weight less than 10,000 atomic mass units comprise, on average, 5 to 10 weight percent siloxane repeating units, specifically 6 to 9 weight percent siloxane repeating units.

Similarly, the reaction product can also include relatively small amounts of very high molecular weight species. Thus, in some embodiments, the reaction product comprises less than 25 weight percent of molecules having a molecular weight greater than 100,000 atomic mass units, specifically 5 to 25 weight percent of molecules having a molecular weight greater than 100,000 atomic mass units, more specifically 7 to 23 weight percent of molecules having a molecular weight greater than 100,000 atomic mass units. In some embodiments, the molecules having a molecular weight greater than 100,000 atomic mass units comprise, on average, 3 to 6 weight percent siloxane repeating units, specifically 4 to 5 weight percent siloxane repeating units.

In a very specific procedure for preparing the poly(phenylene ether)-polysiloxane block copolymer reaction product, the monohydric phenol is 2,6-dimethylphenol; the hydroxyaryl-terminated polysiloxane is a eugenol-capped polydimethylsiloxane comprising 35 to 60 dimethylsiloxane units; the oxidative copolymerization is conducted with a reaction time of 170 to 220 minutes; and the hydroxyaryl-terminated polysiloxane constitutes 2 to 7 weight percent of the combined weight of the monohydric phenol and the hydroxyaryl-terminated polysiloxane.

In some embodiments, the poly(phenylene ether)-polysiloxane block copolymer reaction product comprises 8 to 30 weight percent siloxane repeating units and 70 to 92 weight percent phenylene ether repeating units, based on the total weight of the reaction product. Within these ranges, the amount of siloxane repeating units can be 10 to 27 weight percent, specifically 12 to 24 weight percent, more specifically 14 to 22 weight percent, even more specifically 16 to 20 weight percent; and the amount of phenylene ether repeating units can be 74 to 90 weight percent, specifically 76 to 88 weight percent, more specifically 78 to 86 weight percent, yet more specifically 80 to 84 weight percent.

In some embodiments, the poly(phenylene ether)-polysiloxane block copolymer reaction product comprises 15 to 25 weight percent siloxane repeating units and 75 to 85 weight percent phenylene ether repeating units. Within the range of 15 to 25 weight percent siloxane repeating units, the weight percent of siloxane repeating units can be 16 to 24 weight percent, specifically 17 to 22 weight percent, even more specifically 18 to 20 weight percent. Within the range of 75 to 85 weight percent, the weight percent of phenylene ether repeating units can be 76 to 84 weight percent, specifically 78 to 83 weight percent, more specifically 80 to 82 weight percent. These repeating unit amounts are particularly applicable to reaction product after precipitation from isopropanol, which substantially removes free hydroxyaryl-terminated polysiloxane.

In a very specific embodiment of the poly(phenylene ether)-polysiloxane block copolymer reaction product, the monohydric phenol is 2,6-dimethylphenol; the hydroxyaryl-terminated polysiloxane is a eugenol-capped polydimethylsiloxane comprising 30 to 60 dimethylsiloxane units; the hydroxyaryl-terminated polysiloxane constitutes 10 to 28 weight percent, specifically 14 to 26 weight percent, more specifically 18 to 24 weight percent of the combined weight of the monohydric phenol and the hydroxyaryl-terminated polysiloxane; the reaction product incorporates greater than 85 weight percent of the hydroxyaryl-terminated polysiloxane into the poly(phenylene ether)-polysiloxane block copolymer; the reaction product comprises 15 to 25 weight percent, specifically 16 to 24 weight percent, more specifically 17 to 22 weight percent, even more specifically 18 to 20 weight percent siloxane repeating units and 75 to 85 weight percent, specifically 76 to 84 weight percent, more specifically 78 to 83 weight percent, even more specifically 80 to 82 weight percent phenylene ether repeating units, based on the total weight of the reaction product; and the reaction product has a weight average molecular weight of 30,000 to 150,000 atomic mass units.

In another embodiment, the poly(phenylene ether)-polysiloxane block copolymer reaction product comprises a poly(phenylene ether), and a poly(phenylene ether)-polysiloxane block copolymer comprising a poly(phenylene ether) block, and a polysiloxane block comprising, on average, 20 to 80 siloxane repeating units, specifically 25 to 70 siloxane repeating units, more specifically 30 to 60 siloxane repeating units, even more specifically 35 to 50 siloxane repeating units, still more specifically 40 to 50 siloxane repeating units; wherein the reaction product comprises greater than 8 to 30 weight percent, specifically 10 to 27 weight percent, more specifically 12 to 24 weight percent, even more specifically 14 to 22 weight percent, yet more specifically 16 to 20 weight percent siloxane repeating units, and 70 to less than 92 weight percent, specifically 74 to 90 weight percent, more specifically 77 to 88 weight percent, even more specifically 78 to 86 weight percent, yet more specifically 84 to 80 weight percent phenylene ether repeating units, based on the total weight of the reaction product; wherein the reaction product is the product of a process comprising oxidatively copolymerizing a monomer mixture comprising a monohydric phenol and a hydroxyaryl-terminated polysiloxane; and wherein the reaction product has a weight average molecular weight of at least 30,000 atomic mass units, specifically 30,000 to 150,000 atomic mass units, more specifically 35,000 to 120,000 atomic mass units, still more specifically 40,000 to 90,000 atomic mass units, yet more specifically 45,000 to 70,000 atomic mass units.

In a specific embodiment of the poly(phenylene ether)-polysiloxane block copolymer reaction product, the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof; the poly(phenylene ether)-polysiloxane block copolymer comprises a polysiloxane block comprising repeating units having the structure

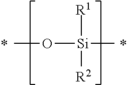

wherein each occurrence of R¹ and R² is independently hydrogen, C₁-C₁₂ hydrocarbyl, or C₁-C₁₂ halohydrocarbyl; and the polysiloxane block further comprises a terminal unit having the structure

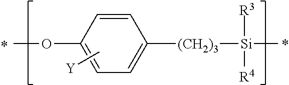

wherein Y is hydrogen, C₁-C₁₂ hydrocarbyl, C₁-C₁₂ hydrocarbyloxy, or halogen, and wherein each occurrence of R³ and R⁴ is independently hydrogen, C₁-C₁₂, hydrocarbyl, or C₁-C₁₂ halohydrocarbyl.

The composition comprises 1 to 15 weight percent of the poly(phenylene ether)-polysiloxane block copolymer reaction product, based on the total weight of the composition. In some embodiments, including some embodiments in which the composition comprises less than 5 weight percent, specifically less than 2 weight percent of the surface-treated Boehmite, the amount of the poly(phenylene ether)-polysiloxane block copolymer reaction product is 3 to 13 weight percent, specifically 7 to 13 weight percent, more specifically 8 to 12 weight percent. In other embodiments, including some embodiments in which the composition comprises 2 to 15 weight percent, specifically 5 to 15 weight percent of the surface-treated Boehmite, the amount of the poly(phenylene ether)-polysiloxane block copolymer reaction product is 5 to 15 weight percent, specifically 7 to 15 weight percent, more specifically 9 to 13 weight percent

In addition to the polyamide and the poly(phenylene ether)-polysiloxane block copolymer reaction product, the components melt blended to form the composition include a flame retardant. The flame retardant comprises a metal dialkylphosphinate, optionally in combination with melamine polyphosphate and/or zinc borate. As used herein, the term “metal dialkylphosphinate” refers to a salt comprising at least one metal cation and at least one dialkylphosphinate anion. In some embodiments, the metal dialkylphosphinate has the formula

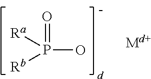

wherein R^{a} and R^{b} are each independently C₁-C₆ alkyl; M is calcium, magnesium, aluminum, or zinc; and d is 2 or 3. Examples of R^{a} and R^{b} include methyl, ethyl, n-propyl, isopropyl, n-butyl, tert-butyl, n-pentyl, and phenyl. In some embodiments, R^{a} and R^{b} are ethyl, M is aluminum, and d is 3 (that is, the metal dialkylphosphinate is aluminum tris(diethylphosphinate)).

In addition to the metal dialkylphosphinate, the flame retardant can, optionally, further comprise melamine polyphosphate and/or zinc borate. In some embodiments, the flame retardant comprises, based on the total weight of the flame retardant, 50 to 76 weight percent, specifically 55 to 70 weight percent, metal dialkylphosphinate; 22 to 49 weight percent, specifically 25 to 40 weight percent, melamine polyphosphate; and 2 to 8 weight percent, specifically 3 to 7 weight percent, zinc borate.

In some embodiments, the flame retardant is in particulate form. The flame retardant particles can have a median particle diameter (D50) less than or equal to 40 micrometers, or, more specifically, a D50 less than or equal to 30 micrometers, or, even more specifically, a D50 less than or equal to 25 micrometers. Additionally, the flame retardant can be combined with a polymer, such as a portion of the polyamide or a portion of the poly(phenylene ether)-polysiloxane block copolymer reaction product, to form a masterbatch. The flame retardant masterbatch comprises the flame retardant at a concentration greater than is present in the composition as a whole. Employing a masterbatch for the addition of the flame retardant to the other components of the composition can facilitate addition and improve distribution of the flame retardant within the composition.

The composition comprises the flame retardant in an amount of 5 to 25 weight percent, based on the total weight of the composition. In some embodiments, including some embodiments in which the composition comprises the surface-treated Boehmite in an amount of less than 5 weight percent, specifically less than 2 weight percent, the flame retardant amount is 10 to 25 weight percent, specifically 11 to 20 weight percent, more specifically 12 to 18 weight percent. In other embodiments, including some embodiments in which the composition comprises 2 to 15 weight percent, specifically 5 to 15 weight percent of the surface-treated Boehmite, the flame retardant amount is 3 to 20 weight percent, specifically 5 to 16 weight percent, more specifically 7 to 13 weight percent.

In some embodiments, the flame retardant comprises 4 to 16 weight percent of the metal dialkylphosphinate, 0.9 to 8 weight percent of the melamine polyphosphate, and 0.1 to 3 weight percent of the zinc borate, based on the total weight of the composition. In some embodiments, including some embodiments in which the composition comprises the surface-treated Boehmite in an amount of less than 5 weight percent, specifically less than 2 weight percent, the metal dialkylphosphinate amount is 6 to 16 weight percent, specifically 6 to 15 weight percent, more specifically 7 to 13 weight percent, even more specifically 7 to 12 weight percent; a melamine polyphosphate amount of 3 to 8 weight percent, specifically 3 to 7 weight percent; and the zinc borate amount is 0.3 to 3 weight percent, specifically 0.4 to 2 weight percent, more specifically 0.4 to 1.5 weight percent. In other embodiments, including some embodiments in which the composition comprises 2 to 15 weight percent, specifically 5 to 15 weight percent of the surface-treated Boehmite, the flame retardant comprises, based on the total weight of the flame retardant, a metal dialkylphosphinate amount of 50 to 76 weight percent, specifically 55 to 70 weight percent; a melamine polyphosphate amount of 22 to 49 weight percent, specifically 25 to 40 weight percent; and a zinc borate amount of 2 to 8 weight percent, specifically 3 to 7 weight percent.

In addition to the polyamide, the poly(phenylene ether)-polysiloxane block copolymer reaction product, and the flame retardant, the components blended to form the composition include glass fibers. Suitable glass fibers include those based on E, A, C, ECR, R, S, D, and NE glasses, as well as quartz. In some embodiments, the glass fiber has a diameter of 2 to 30 micrometers, specifically 5 to 25 micrometers, more specifically 8 to 15 micrometers. In some embodiments, the length of the glass fibers before compounding is 2 to 7 millimeters, specifically 3 to 5 millimeters. The glass fiber can, optionally, include on its surface an adhesion promoter to improve its compatibility with the poly(phenylene ether) and the polystyrene. Adhesion promoters include chromium complexes, silanes, titanates, zircon-aluminates, propylene maleic anhydride copolymers, reactive cellulose esters and the like. Suitable glass fiber is commercially available from suppliers including, for example, Owens Corning, Nippon Electric Glass, PPG, and Johns Manville.

The composition comprises the glass fibers in an amount of 5 to 45 weight percent, based on the total weight of the composition. Within this range, the glass fiber amount can be 10 to 45 weight percent, specifically 15 to 45 weight percent. In some embodiments, including some embodiments in which the composition comprises the surface-treated Boehmite in an amount of less than 5 weight percent, specifically less than 2 weight percent, the glass fiber amount is 5 to 35 weight percent, specifically 15 to 35 weight percent, more specifically 18 to 32 weight percent, even more specifically 20 to 30 weight percent. In other embodiments, including some embodiments in which the composition comprises 2 to 15 weight percent, specifically 5 to 15 weight percent of the surface-treated Boehmite, the glass fiber amount is 5 to 40 weight percent, specifically 10 to 40 weight percent, more specifically 20 to 35 weight percent, even more specifically 20 to 30 weight percent.

In addition to the polyamide, the poly(phenylene ether)-polysiloxane block copolymer reaction product, the flame retardant, and the glass fibers, the composition can, optionally, include up to 15 weight percent of a surface-treated Boehmite Boehmite is an aluminum oxide hydroxide mineral with an ideal formula of AlO(OH). As a practical matter, Boehmite can have a chemical formula of AlOₓ(OH)₃₋₂ₓ, where x is 0.8 to 1. Boehmite occurs naturally in bauxite deposits. Boehmite can also be prepared synthetically as described, for example, in U.S. Pat. No. 6,143,816 to Prescher et al. and U.S. Pat. No. 8,119,096 to Reimer et al.

Surface-treated Boehmite is the product of a process comprising treating Boehmite with a surface treatment agent to enhance the compatibility of the Boehmite with the polyamide. In some embodiments, the surface treatment agent is non-polymeric. Surface treatment agents include, for example, chromium complexes, silanes, titanates, zirco-aluminates, propylene maleic anhydride copolymers, reactive cellulose esters, and the like, and combinations thereof. Specific silane surface treatment agents include γ-aminopropyltrialkoxysilanes (including γ-aminopropyltrimethoxysilane and γ-aminopropyltriethoxysilane), γ-(meth)acryloxypropyltrialkoxysilanes (including γ-acryloxypropyltrimethoxysilane, γ-methacryloxypropyltrimethoxysilane, γ-acryloxypropyltriethoxysilane, and γ-methacryloxypropyltriethoxysilane), β-(3,4-epoxycyclohexyl)ethyltrialkoxysiloxanes (including β-(3,4-epoxycyclohexyl)ethyltrimethoxysiloxane and β-(3,4-epoxycyclohexyl)ethyltriethoxysiloxane), and combinations thereof. The amount of surface treatment agent relative to Boehmite can be 0.05 to 5 weight percent, based on the weight of the Boehmite. Similarly, the resulting surface-treated polar filler will generally comprise 0.05 to 5 weight percent of surface treatment agent residue. Commercially available surface-treated Boehmites include ACTILOX B 60 AS1 and ACTILOX 200 AS1 from Nabaltec. In some embodiments, the surface-treated Boehmite is ACTILOX B 60 AS1.

In some embodiments, the surface-treated Boehmite has a particle diameter D50 of 500 to 1500 nanometers. D50 is the median particle diameter, so half of the particles have a particle diameter greater than D50, and half have a particle diameter less than D50. In some embodiments, the surface-treated Boehmite has a particle diameter D10 of 200 to 600 nanometers, D50 of 600 to 1200 nanometers, and D90 of 1200 to 2600 nanometers. D10 is the particle diameter such that 90 percent of the particles have a particle diameter greater than D10, and 10 percent have a particle diameter less than D10. D90 is the particle diameter such that 10 percent of the particles have a particle diameter greater than D90, and 90 percent have a particle diameter less than D90. Methods for determining D10, D50, and D90 values are known in the art and include laser diffraction and dynamic light scattering.

When present, the surface-treated Boehmite can be used in an amount of up to 15 weight percent. In some embodiments, the composition excludes surface-treated Boehmite. In other embodiments, the composition comprises surface-treated Boehmite in an amount of 2 to 15 weight percent, specifically 3 to 13 weight percent, more specifically 4 to 11 weight percent, based on the total weight of the composition.

The melt blended components can, optionally, further include a compatibilizing agent. As used herein, the term “compatibilizing agent” refers to a polyfunctional compound that interacts with the poly(phenylene ether)-polysiloxane block copolymer reaction product, the polyamide, or both. This interaction can be chemical (for example, grafting) and/or physical (for example, affecting the surface characteristics of the dispersed phases). In either instance the resulting blend of polyamide and poly(phenylene ether)-polysiloxane block copolymer reaction product exhibits improved compatibility, particularly as evidenced by enhanced impact strength, mold knit line strength, and/or tensile elongation.

Examples of compatibilizing agents that can be employed include liquid diene polymers, epoxy compounds, oxidized polyolefin wax, quinones, organosilane compounds, polyfunctional compounds, functionalized poly(phenylene ether)s, and combinations thereof. Compatibilizing agents are further described in U.S. Pat. No. 5,132,365 to Gallucci, and U.S. Pat. Nos. 6,593,411 and 7,226,963 to Koevoets et al.

In some embodiments, the compatibilizing agent comprises a polyfunctional compound. Polyfunctional compounds that can be employed as a compatibilizing agent are typically of three types. The first type of polyfunctional compound has in the molecule both (a) a carbon-carbon double bond or a carbon-carbon triple bond and (b) at least one carboxylic acid, anhydride, amide, ester, imide, amino, epoxy, orthoester, or hydroxy group. Examples of such polyfunctional compounds include maleic acid; maleic anhydride; fumaric acid; glycidyl acrylate, itaconic acid; aconitic acid; maleimide; maleic hydrazide; reaction products resulting from a diamine and maleic anhydride, maleic acid, fumaric acid, etc.; dichloro maleic anhydride; maleic acid amide; unsaturated dicarboxylic acids (for example, acrylic acid, butenoic acid, methacrylic acid, ethylacrylic acid, pentenoic acid, decenoic acids, undecenoic acids, dodecenoic acids, linoleic acid, etc.); esters, acid amides or anhydrides of the foregoing unsaturated carboxylic acids; unsaturated alcohols (for example, alkanols, crotyl alcohol, methyl vinyl carbinol, 4-pentene-1-ol, 1,4-hexadiene-3-ol, 3-butene-1,4-diol, 2,5-dimethyl-3-hexene-2,5-diol, and alcohols of the formula CₙH₂ₙ₋₅OH, CₙH₂ₙ₋₇OH and CₙH₂ₙ₋₉O, wherein n is a positive integer less than or equal to 30); unsaturated amines resulting from replacing from replacing the —OH group(s) of the above unsaturated alcohols with —NH₂ group(s); and combinations comprising one or more of the foregoing. In some embodiment, the compatibilizing agent comprises maleic anhydride and/or fumaric acid. In some embodiments, the compatibilizing agent comprises fumaric acid.

The second type of polyfunctional compatibilizing agent has both (a) a group represented by the formula (OR) wherein R is hydrogen or an alkyl, aryl, acyl or carbonyl dioxy group and (b) at least two groups each of which can be the same or different selected from carboxylic acid, acid halide, anhydride, acid halide anhydride, ester, orthoester, amide, imido, amino, and various salts thereof. Typical of this group of compatibilizing agents are the aliphatic polycarboxylic acids, acid esters, and acid amides represented by the formula:

(R^{I}O)ₘR′(COOR^{II})ₙ(CONR^{III}R^{IV})ₛ

wherein R′ is a linear or branched chain, saturated aliphatic hydrocarbon having 2 to 20, or, more specifically, 2 to 10, carbon atoms; R^{I} is hydrogen or an alkyl, aryl, acyl, or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III} and R^{IV} are independently hydrogen or an alkyl or aryl group having 1 to 10, or, more specifically, 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (OR^{I}) is alpha or beta to a carbonyl group and at least two carbonyl groups are separated by 2 to 6 carbon atoms. Obviously, R^{I}, R^{II}, R^{III}, and R^{IV} cannot be aryl when the respective substituent has less than 6 carbon atoms.

Suitable polycarboxylic acids include, for example, citric acid, malic acid, and agaricic acid, including the various commercial forms thereof, such as for example, the anhydrous and hydrated acids; and combinations comprising one or more of the foregoing. In one embodiment, the compatibilizing agent comprises citric acid. Illustrative of esters useful herein include, for example, acetyl citrate, monostearyl and/or distearyl citrates, and the like. Suitable amides useful herein include, for example, N,N′-diethyl citric acid amide; N-phenyl citric acid amide; N-dodecyl citric acid amide; N,N′-didodecyl citric acid amide; and N-dodecyl malic acid. Derivatives include the salts thereof, including the salts with amines and the alkali and alkaline metal salts. Examples of suitable salts include calcium malate, calcium citrate, potassium malate, and potassium citrate.

The third type of polyfunctional compatibilizing agent has in the molecule both (a) an acid halide group and (b) at least one carboxylic acid, anhydride, ester, epoxy, orthoester, or amide group, preferably a carboxylic acid or anhydride group. Examples of compatibilizing agents within this group include trimellitic anhydride acid chloride, chloroformyl succinic anhydride, chloroformyl succinic acid, chloroformyl glutaric anhydride, chloroformylglutaric acid, chloroacetylsuccinic anhydride, chloroacetylsuccinic acid, trimellitic acid chloride, and chloroacetylglutaric acid. In some embodiments, the compatibilizing agent comprises trimellitic anhydride acid chloride.

In some embodiments, the compatibilizing agent is selected from citric acid, fumaric acid, maleic acid, maleic anhydride, and combinations thereof. Citric acid is a presently preferred compatibilizing agent. The foregoing compatibilizing agents can be added directly to the melt blend or pre-reacted with either or both of the poly(phenylene ether) and the polyamide.

When present, the compatibilizing agent is used in an amount of 0.2 to 2 weight percent, based on the total weight of the composition. In some embodiments, the compatibilizing agent amount is 0.3 to 1.5 weight percent, specifically 0.4 to 1 weight percent. In some embodiments, the compatibilizing agent amount is 0.4 to 1.5 weight percent, specifically 0.6 to 1 weight percent. As demonstrated in the working examples below, it is also possible to prepare the composition without including a compatibilizing agent among the melt blended components.

The composition can, optionally, further include one or more additives. For example, the composition can, optionally, further comprise an additive chosen from stabilizers, mold release agents, lubricants, processing aids, drip retardants, nucleating agents, UV blockers, dyes, pigments, antioxidants, anti-static agents, blowing agents, mineral oil, metal deactivators, antiblocking agents, and the like, and combinations thereof. When present, such additives are typically used in a total amount of less than or equal to 5 weight percent, specifically less than or equal to 2 weight percent, more specifically less than or equal to 1 weight percent, based on the total weight of the composition. Aluminum stearate and pentaerythritol tetrastearate are particularly suitable lubricants.

The composition can, optionally, exclude electrically conductive fillers in order to maximize electrical resistivity. Electrically conductive fillers include carbon nanotubes and electrically conductive carbon black.

The composition can, optionally, exclude impact modifiers to maintain a high stiffness in articles molded from the composition.

A very specific embodiment is a composition comprising the product of melt blending: 44 to 52 weight percent of polyamide-6,6; 8 to 12 weight percent of a poly(phenylene ether)-polysiloxane block copolymer reaction product comprising a poly(phenylene ether) and a poly(phenylene ether)-polysiloxane block copolymer; wherein the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof, wherein the poly(phenylene ether)-polysiloxane block copolymer comprises a polysiloxane block comprising repeating units having the structure

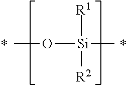

wherein each occurrence of R¹ and R² is independently hydrogen, C₁-C₁₂ hydrocarbyl, or C₁-C₁₂ halohydrocarbyl; and the polysiloxane block further comprises a terminal unit having the structure

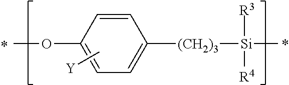

wherein Y is hydrogen, C₁-C₁₂ hydrocarbyl, C₁-C₁₂ hydrocarbyloxy, or halogen, and wherein each occurrence of R³ and R⁴ is independently hydrogen, C₁-C₁₂, hydrocarbyl, or C₁-C₁₂ halohydrocarbyl; 12 to 18 weight percent of a flame retardant comprising 7 to 12 weight percent of aluminum tris(diethylphosphinate), 3 to 7 weight percent of melamine polyphosphate, and 0.4 to 1.5 weight percent of zinc borate; 0.2 to 2 weight percent of a compatibilizing agent selected from the group consisting of citric acid, fumaric acid, maleic acid, maleic anhydride, and combinations thereof; and 20 to 30 weight percent of glass fibers; wherein all weight percents are based on the total weight of the composition.

In another very specific embodiment, the composition comprises the product of melt blending: 40 to 53 weight percent of a polyamide-6,6; 9 to 13 weight percent of a poly(phenylene ether)-polysiloxane block copolymer reaction product comprising a poly(phenylene ether) and a poly(phenylene ether)-polysiloxane block copolymer; 7.3 to 12.8 weight percent of a flame retardant comprising 5 to 8 weight percent of a metal dialkylphosphinate, 2 to 4 weight percent of melamine polyphosphate, and 0.3 to 0.8 weight percent of zinc borate; 0.2 to 2 weight percent of a compatibilizing agent selected from the group consisting of citric acid, fumaric acid, maleic acid, maleic anhydride, and combinations thereof; 3 to 11 weight percent of a surface-treated Boehmite; and 20 to 30 weight percent of glass fibers; wherein all weight percents are based on the total weight of the composition.

The invention includes methods of forming the composition. Thus, one embodiment is a method of forming a composition, the method comprising: melt blending 30 to 89 weight percent of a polyamide; 1 to 15 weight percent of a poly(phenylene ether)-polysiloxane block copolymer reaction product comprising a poly(phenylene ether) and a poly(phenylene ether)-polysiloxane block copolymer; 5 to 25 weight percent of a flame retardant comprising 4 to 16 weight percent of a metal dialkylphosphinate, 0.9 to 8 weight percent of melamine polyphosphate, and 0.1 to 3 weight percent of zinc borate; 5 to 45 weight percent of glass fibers; and 0 to 15 weight percent of a surface-treated Boehmite to form the composition; wherein the composition comprises 5 to 20 weight percent of the flame retardant when the composition comprises 5 to 15 weight percent of the surface-treated Boehmite; wherein the composition comprises greater than 10 to 25 weight percent of the flame retardant when the composition comprises 0 to less than 5 weight percent of the surface-treated Boehmite; and wherein all weight percents are based on the total weight of the composition.

Another embodiment is a method of forming a composition, the method comprising: melt blending 40 to 60 weight percent of a polyamide; 1 to 15 weight percent of a poly(phenylene ether)-polysiloxane block copolymer reaction product comprising a poly(phenylene ether) and a poly(phenylene ether)-polysiloxane block copolymer; 10 to 25 weight percent of a flame retardant comprising 6 to 16 weight percent of a metal dialkylphosphinate, 3 to 8 weight percent of melamine polyphosphate, and 0.3 to 3 weight percent of zinc borate; and 15 to 35 weight percent of glass fibers to form the composition; wherein all weight percents are based on the total weight of the composition.

Another embodiment is a method of forming a composition, the method comprising: melt blending 30 to 74.8 weight percent of a polyamide; 5 to 15 weight percent of a poly(phenylene ether)-polysiloxane block copolymer reaction product comprising a poly(phenylene ether) and a poly(phenylene ether)-polysiloxane block copolymer; 3 to 20 weight percent of a flame retardant comprising 3 to 9 a metal dialkylphosphinate; 0.2 to 2 weight percent of a compatibilizing agent; 2 to 15 weight percent of a surface-treated Boehmite; and 15 to 45 weight percent of glass fibers to form the composition; wherein all weight percents are based on the total weight of the composition.

All of the compositional variations described above in the context of the composition apply as well to the methods of forming the composition. The invention further includes compositions formed by any of the variations of the method.

The composition can be prepared by melt-blending the individual components. The melt-blending or melt-kneading can be performed using common equipment such as ribbon blenders, Henschel mixers, Banbury mixers, drum tumblers, single-screw extruders, twin-screw extruders, multi-screw extruders, co-kneaders, and the like. For example, the present composition can be prepared by melt-blending the components in a twin-screw extruder at a temperature of 240 to 280° C., specifically 250 to 270° C.

The invention includes articles comprising the composition and all of its variations. The composition is particularly useful for forming parts for electrical components, such parts including photovoltaic junction boxes and connectors, inverter housings, automotive electrical connectors, electrical relays, and charge couplers. Suitable methods of forming articles include single layer and multilayer sheet extrusion, injection molding, blow molding, film extrusion, profile extrusion, pultrusion, compression molding, thermoforming, pressure forming, hydroforming, vacuum forming, and the like. Combinations of the foregoing article fabrication methods can be used. A skilled person can determine specific article-forming conditions. For example, injection molding can utilize a melt temperature of 240 to 300° C. and a mold temperature of 60 to 120° C.

All ranges disclosed herein are inclusive of the endpoints, and the endpoints are independently combinable with each other. Each range disclosed herein constitutes a disclosure of any point or sub-range lying within the disclosed range.

The invention includes at least the following embodiments.

### Embodiment 1

A composition comprising the product of melt blending: 30 to 89 weight percent of a polyamide; 1 to 15 weight percent of a poly(phenylene ether)-polysiloxane block copolymer reaction product comprising a poly(phenylene ether) and a poly(phenylene ether)-polysiloxane block copolymer; 5 to 25 weight percent of a flame retardant comprising 4 to 16 weight percent of a metal dialkylphosphinate, 0.9 to 8 weight percent of melamine polyphosphate, and 0.1 to 3 weight percent of zinc borate; 5 to 45 weight percent of glass fibers; and 0 to 15 weight percent of a surface-treated Boehmite; wherein the composition comprises 5 to 20 weight percent of the flame retardant when the composition comprises 5 to 15 weight percent of the surface-treated Boehmite; wherein the composition comprises greater than 10 to 25 weight percent of the flame retardant when the composition comprises 0 to less than 5 weight percent of the surface-treated Boehmite; and wherein all weight percents are based on the total weight of the composition.

### Embodiment 2

The composition of Embodiment 1, exhibiting a comparative tracking index of at least 475 volts measured according to IEC-60112, Third edition, and a 20 millimeter Vertical Burning Test rating of V-0 measured according to Underwriters Laboratory UL 94 “Tests for Flammability of Plastic Materials for Parts in Devices and Appliances”.

### Embodiment 3

The composition of Embodiment 2, exhibiting a comparative tracking index of 475 to 600 volts.

### Embodiment 4

The composition of any of Embodiments 1-3, wherein the polyamide comprises polyamide-6,6.

### Embodiment 5

The composition of any of Embodiments 1-4, wherein the poly(phenylene ether)-polysiloxane block copolymer comprises a poly(phenylene ether) block and a polysiloxane block, and wherein the composition comprises 0.2 to 2 weight percent of the polysiloxane block.

### Embodiment 6

The composition of any of Embodiments 1-5, wherein the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof, and wherein the poly(phenylene ether)-polysiloxane block copolymer comprises a polysiloxane block comprising repeating units having the structure

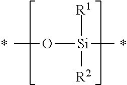

wherein each occurrence of R¹ and R² is independently hydrogen, C₁-C₁₂ hydrocarbyl, or C₁-C₁₂ halohydrocarbyl; and the polysiloxane block further comprises a terminal unit having the structure

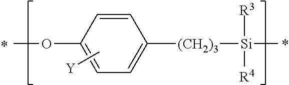

wherein Y is hydrogen, C₁-C₁₂ hydrocarbyl, C₁-C₁₂ hydrocarbyloxy, or halogen, and wherein each occurrence of R³ and R⁴ is independently hydrogen, C₁-C₁₂, hydrocarbyl, or C₁-C₁₂ halohydrocarbyl.

### Embodiment 7

The composition of any of Embodiments 1-6, wherein the flame retardant comprises, based on the total weight of the flame retardant, 50 to 76 weight percent of the metal dialkylphosphinate, 22 to 49 weight percent of the melamine polyphosphate, and 2 to 8 weight percent of the zinc borate.

### Embodiment 8

The composition of Embodiment 1, wherein the polyamide comprises polyamide-6,6; wherein the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof; wherein the poly(phenylene ether)-polysiloxane block copolymer comprises a polysiloxane block comprising repeating units having the structure

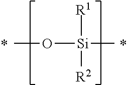

wherein each occurrence of R¹ and R² is independently hydrogen, C₁-C₁₂ hydrocarbyl, or C₁-C₁₂ halohydrocarbyl; and the polysiloxane block further comprises a terminal unit having the structure

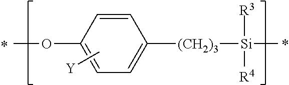

wherein Y is hydrogen, C₁-C₁₂ hydrocarbyl, C₁-C₁₂ hydrocarbyloxy, or halogen, and wherein each occurrence of R³ and R⁴ is independently hydrogen, C₁-C₁₂, hydrocarbyl, or C₁-C₁₂ halohydrocarbyl; wherein the composition comprises 44 to 52 weight percent of the polyamide, 8 to 12 weight percent of the poly(phenylene ether)-polysiloxane block copolymer reaction product, 12 to 18 weight percent of the flame retardant comprising 7 to 12 weight percent of aluminum tris(diethylphosphinate), 3 to 7 weight percent of melamine polyphosphate, and 0.4 to 1.5 weight percent of zinc borate, and 20 to 30 weight percent of the glass fibers; and wherein the composition further comprises 0.2 to 2 weight percent of a compatibilizing agent selected from the group consisting of citric acid, fumaric acid, maleic acid, maleic anhydride, and combinations thereof.

### Embodiment 9

The composition of Embodiment 1, wherein the composition comprises 30 to 74.8 weight percent of the polyamide; wherein the composition comprises 5 to 15 weight percent of the poly(phenylene ether)-polysiloxane block copolymer reaction product; wherein the composition comprises 3 to 20 weight percent of the flame retardant; wherein the composition comprises 2 to 15 weight percent of the surface-treated Boehmite; and wherein the composition further comprises 0.2 to 2 weight percent of a compatibilizing agent.

### Embodiment 10

The composition of Embodiment 9, wherein the surface-treated Boehmite has a particle diameter characterized by a D 10 of 200 to 600 nanometers, a D50 of 600 to 1200 nanometers, and a D90 of 1200 to 2600 nanometers.

### Embodiment 11

The composition of Embodiment 9 or 10, wherein the polyamide comprises polyamide-6,6; wherein the compatibilizing agent is selected from the group consisting of citric acid, fumaric acid, maleic acid, maleic anhydride, and combinations thereof; and wherein the composition comprises 40 to 53 weight percent of the polyamide, 9 to 13 weight percent of the poly(phenylene ether)-polysiloxane block copolymer reaction product, 7.3 to 12.8 weight percent of the flame retardant comprising 5 to 8 weight percent of the metal dialkylphosphinate and 2 to 4 weight percent of the melamine polyphosphate and 0.3 to 0.8 weight percent of the zinc borate, 3 to 11 weight percent of the surface-treated Boehmite, and 20 to 30 weight percent of the glass fibers.

### Embodiment 12

An article comprising the composition of any of Embodiments 1-11.

### Embodiment 13

The article of Embodiment 12, wherein the polyamide comprises polyamide-6,6; wherein the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof; wherein the poly(phenylene ether)-polysiloxane block copolymer comprises a polysiloxane block comprising repeating units having the structure

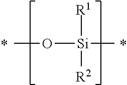

wherein each occurrence of R¹ and R² is independently hydrogen, C₁-C₁₂ hydrocarbyl, or C₁-C₁₂ halohydrocarbyl; and the polysiloxane block further comprises a terminal unit having the structure

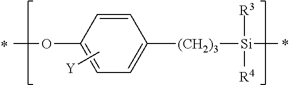

wherein Y is hydrogen, C₁-C₁₂, hydrocarbyl, C₁-C₁₂, hydrocarbyloxy, or halogen, and wherein each occurrence of R³ and R⁴ is independently hydrogen, C₁-C₁₂ hydrocarbyl, or C₁-C₁₂ halohydrocarbyl; wherein the composition comprises 44 to 52 weight percent of the polyamide, 8 to 12 weight percent of the poly(phenylene ether)-polysiloxane block copolymer reaction product, 12 to 18 weight percent of the flame retardant comprising 7 to 12 weight percent of aluminum tris(diethylphosphinate) and 3 to 7 weight percent of melamine polyphosphate and 0.4 to 1.5 weight percent of zinc borate, and 20 to 30 weight percent of the glass fibers; and wherein the composition further comprises 0.2 to 2 weight percent of a compatibilizing agent selected from the group consisting of citric acid, fumaric acid, maleic acid, maleic anhydride, and combinations thereof.

### Embodiment 14

The article of Embodiment 12 or 13, wherein the article is or is part of a photovoltaic junction box, a photovoltaic junction connector, an inverter housing, an electrical connector, an electrical relay, or a charge coupler.

### Embodiment 15

The article of Embodiment 12, wherein the composition comprises 30 to 74.8 weight percent of the polyamide; wherein the composition comprises 5 to 15 weight percent of the poly(phenylene ether)-polysiloxane block copolymer reaction product; wherein the composition comprises 3 to 20 weight percent of the flame retardant; wherein the composition comprises 2 to 15 weight percent of the surface-treated Boehmite; and wherein the composition further comprises 0.2 to 2 weight percent of a compatibilizing agent.

### Embodiment 16

The article of Embodiment 15, wherein the polyamide comprises polyamide-6,6; wherein the compatibilizing agent is selected from the group consisting of citric acid, fumaric acid, maleic acid, maleic anhydride, and combinations thereof; and wherein the composition comprises 40 to 53 weight percent of the polyamide, 9 to 13 weight percent of the poly(phenylene ether)-polysiloxane block copolymer reaction product, 7.3 to 12.8 weight percent of the flame retardant comprising 5 to 8 weight percent of the metal dialkylphosphinate and 2 to 4 weight percent of the melamine polyphosphate and 0.3 to 0.8 weight percent of the zinc borate, 3 to 11 weight percent of the surface-treated Boehmite, and 20 to 30 weight percent of the glass fibers.

### Embodiment 17

The article of Embodiment 15 or 16, wherein the article is or is part of a photovoltaic junction box, a photovoltaic junction connector, an inverter housing, an electrical connector, an electrical relay, or a charge coupler.

### Embodiment A1

A composition comprising the product of melt blending components comprising: 40 to 60 weight percent of a polyamide; 1 to 15 weight percent of a poly(phenylene ether)-polysiloxane block copolymer reaction product comprising a poly(phenylene ether) and a poly(phenylene ether)-polysiloxane block copolymer; 10 to 25 weight percent of a flame retardant comprising 6 to 16 weight percent of a metal dialkylphosphinate, 3 to 8 weight percent of melamine polyphosphate, and 0.3 to 3 weight percent of zinc borate; and 15 to 35 weight percent of glass fibers; wherein all weight percents are based on the total weight of the composition.

### Embodiment A2

The composition of Embodiment A1, exhibiting a comparative tracking index of at least 475 volts measured according to IEC-60112, Third edition, and a 20 millimeter Vertical Burning Test rating of V-0 measured according to Underwriters Laboratory UL 94 “Tests for Flammability of Plastic Materials for Parts in Devices and Appliances”.

### Embodiment A3

The composition of Embodiment A2, exhibiting a comparative tracking index of 475 to 600 volts.

### Embodiment A4

The composition of any of Embodiments A1-A3, wherein the polyamide is selected from the group consisting of polyamide-6, polyamide-6,6, polyamide-4,6, polyamide-11, polyamide-12, polyamide-6,10, polyamide-6,12, polyamide 6/6,6, polyamide-6/6,12, polyamide MXD,6, polyamide-6,T, polyamide-6,I, polyamide-6/6,T, polyamide-6/6,I, polyamide-6,6/6,T, polyamide-6,6/6,I, polyamide-6/6,T/6,I, polyamide-6,6/6,T/6,I, polyamide-6/12/6,T, polyamide-6,6/12/6,T, polyamide-6/12/6,I, polyamide-6,6/12/6,I, and combinations thereof.

### Embodiment A5

The composition of any of Embodiments A1-A3, wherein the polyamide comprises polyamide-6, polyamide-6,6, or a combination thereof.

### Embodiment A6

The composition of any of Embodiments A1-A3, wherein the polyamide comprises polyamide-6,6.

### Embodiment A7

The composition of any of Embodiment A1-A6, wherein the poly(phenylene ether)-polysiloxane block copolymer comprises a poly(phenylene ether) block and a polysiloxane block, and wherein the composition comprises 0.2 to 1 weight percent of the polysiloxane block.

### Embodiment A8

The composition of Embodiment A1, wherein the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof, and wherein the poly(phenylene ether)-polysiloxane block copolymer comprises a polysiloxane block comprising repeating units having the structure

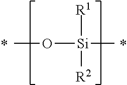

wherein each occurrence of R¹ and R² is independently hydrogen, C₁-C₁₂ hydrocarbyl, or C₁-C₁₂ halohydrocarbyl; and the polysiloxane block further comprises a terminal unit having the structure

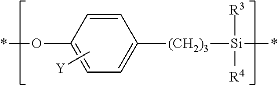

wherein Y is hydrogen, C₁-C₁₂, hydrocarbyl, C₁-C₁₂, hydrocarbyloxy, or halogen, and wherein each occurrence of R³ and R⁴ is independently hydrogen, C₁-C₁₂, hydrocarbyl, or C₁-C₁₂ halohydrocarbyl.

### Embodiment A9

The composition of any of Embodiments A1-A8, wherein the flame retardant comprises, based on the total weight of the flame retardant, 50 to 76 weight percent of the metal dialkylphosphinate, 22 to 49 weight percent of the melamine polyphosphate, and 2 to 8 weight percent of the zinc borate.

### Embodiment A10

The composition of Embodiment A1, wherein the polyamide comprises polyamide-6,6; wherein the melt blended components comprise 44 to 52 weight percent of the polyamide; wherein the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof; wherein the poly(phenylene ether)-polysiloxane block copolymer comprises a polysiloxane block comprises repeating units having the structure

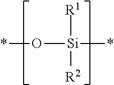

wherein each occurrence of R¹ and R² is independently hydrogen, C₁-C₁₂ hydrocarbyl, or C₁-C₁₂ halohydrocarbyl; wherein the polysiloxane block further comprises a terminal unit having the structure

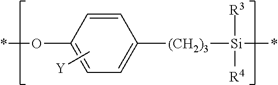

wherein Y is hydrogen, C₁-C₁₂, hydrocarbyl, hydrocarbyloxy, or halogen, and wherein each occurrence of R³ and R⁴ is independently hydrogen, C₁-C₁₂ hydrocarbyl, or C₁-C₁₂ halohydrocarbyl; wherein the melt blended components comprise 8 to 12 weight percent of the poly(phenylene ether)-polysiloxane block copolymer reaction product; wherein the melt blended components comprise 12 to 18 weight percent of the flame retardant; wherein the flame retardant comprises 7 to 12 weight percent of aluminum tris(diethylphosphinate), 3 to 7 weight percent of melamine polyphosphate, and 0.4 to 1.5 weight percent of zinc borate; wherein the melt blended components further comprise 0.2 to 2 weight percent of a compatibilizing agent selected from the group consisting of citric acid, fumaric acid, maleic acid, maleic anhydride, and combinations thereof; and wherein the composition comprises 20 to 30 weight percent of the glass fibers.

### Embodiment A10a

A composition comprising the product of melt blending: 44 to 52 weight percent of polyamide-6,6; 8 to 12 weight percent of a poly(phenylene ether)-polysiloxane block copolymer reaction product comprising a poly(phenylene ether) and a poly(phenylene ether)-polysiloxane block copolymer; wherein the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof; wherein the poly(phenylene ether)-polysiloxane block copolymer comprises a polysiloxane block comprising repeating units having the structure

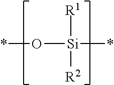

wherein each occurrence of R¹ and R² is independently hydrogen, C₁-C₁₂ hydrocarbyl, or C₁-C₁₂ halohydrocarbyl; and the polysiloxane block further comprises a terminal unit having the structure

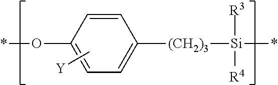

wherein Y is hydrogen, C₁-C₁₂ hydrocarbyl, C₁-C₁₂ hydrocarbyloxy, or halogen, and wherein each occurrence of R³ and R⁴ is independently hydrogen, C₁-C₁₂ hydrocarbyl, or C₁-C₁₂ halohydrocarbyl; 12 to 18 weight percent of a flame retardant comprising 7 to 12 weight percent of aluminum tris(diethylphosphinate), 3 to 7 weight percent of melamine polyphosphate, and 0.4 to 1.5 weight percent of zinc borate; 0.2 to 2 weight percent of a compatibilizing agent selected from the group consisting of citric acid, fumaric acid, maleic acid, maleic anhydride, and combinations thereof; and 20 to 30 weight percent of glass fibers;

wherein all weight percents are based on the total weight of the composition.

### Embodiment A11

An article comprising the composition of any of Embodiments A1-A10 and A10a.

### Embodiment A12

The article of Embodiment A11, wherein the polyamide comprises polyamide-6,6; wherein the melt blended components comprise 44 to 52 weight percent of the polyamide-6,6; wherein the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof; wherein the poly(phenylene ether)-polysiloxane block copolymer comprises a polysiloxane block comprising polydimethylsiloxane repeating units having the structure

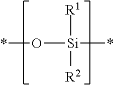

wherein each occurrence of R¹ and R² is independently hydrogen, C₁-C₁₂ hydrocarbyl, or C₁-C₁₂ halohydrocarbyl; and the polysiloxane block further comprises a terminal unit having the structure

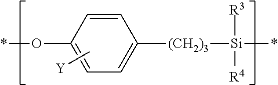

wherein Y is hydrogen, C₁-C₁₂ hydrocarbyl, C₁-C₁₂ hydrocarbyloxy, or halogen, and wherein each occurrence of R³ and R⁴ is independently hydrogen, C₁-C₁₂, hydrocarbyl, or C₁-C₁₂ halohydrocarbyl; wherein the melt blended components comprise 8 to 12 weight percent of the poly(phenylene ether)-polysiloxane block copolymer reaction product; wherein the metal dialkylphosphinate comprises aluminum tris(diethylphosphinate); wherein the melt blended components comprise 12 to 18 weight percent of the flame retardant, and the flame retardant comprises 7 to 12 weight percent of the metal dialkylphosphinate, 3 to 7 weight percent of melamine polyphosphate, and 0.4 to 1.5 weight percent of zinc borate; wherein the melt blended components comprise 20 to 30 weight percent of the glass fibers; and wherein the melt blended components further comprise 0.2 to 2 weight percent of a compatibilizing agent selected from the group consisting of citric acid, fumaric acid, maleic acid, maleic anhydride, and combinations thereof.

### Embodiment A13

The article of Embodiment A11 or A12, wherein the article is or is part of a photovoltaic junction box, a photovoltaic junction connector, an inverter housing, an electrical connector, an electrical relay, or a charge coupler.

### Embodiment B1

A composition comprising the product of melt blending: 30 to 74.8 weight percent of a polyamide; 5 to 15 weight percent of a poly(phenylene ether)-polysiloxane block copolymer reaction product comprising a poly(phenylene ether) and a poly(phenylene ether)-polysiloxane block copolymer; 3 to 20 weight percent of a flame retardant comprising 3 to 9 weight percent of a metal dialkylphosphinate; 0.2 to 2 weight percent of a compatibilizing agent; 2 to 15 weight percent of a surface-treated Boehmite; and 15 to 45 weight percent of glass fibers; wherein all weight percents are based on the total weight of the composition.

### Embodiment B2

The composition of Embodiment B1, exhibiting a melt viscosity less than or equal to 160 pascal-seconds measured according to ISO 11443:2005 at 282° C. and a shear rate of 1,500 second⁻¹, a comparative tracking index of at least 525 volts measured according to IEC-60112, Third edition, and a 20 millimeter Vertical Burning Test rating of V-1 or V-0 measured according to Underwriters Laboratory UL 94 “Tests for Flammability of Plastic Materials for Parts in Devices and Appliances”.

### Embodiment B3

The composition of Embodiment B2, wherein the melt viscosity is 120 to 160 Pascal-seconds, and wherein the comparative tracking index is 525 to 600 volts.

### Embodiment B4

The composition of any of Embodiments B1-B3, wherein the polyamide is selected from the group consisting of polyamide-6, polyamide-6,6, polyamide-4,6, polyamide-11, polyamide-12, polyamide-6,10, polyamide-6,12, polyamide 6/6,6, polyamide-6/6,12, polyamide MXD (m-xylylene diamine),6, polyamide-6,T, polyamide-6,I, polyamide-6/6,T, polyamide-6/6,I, polyamide-6,6/6,T, polyamide-6,6/6,I, polyamide-6/6,T/6,I, polyamide-6,6/6,T/6,I, polyamide-6/12/6,T, polyamide-6,6/12/6,T, polyamide-6/12/6,I, polyamide-6,6/12/6,I, and combinations thereof.

### Embodiment B5

The composition of any of Embodiments B1-B4, wherein the polyamide is selected from the group consisting of polyamide-6, polyamide-6,6, and combinations thereof.

### Embodiment B6

The composition of any of Embodiments B1-B5, wherein the polyamide is polyamide-6,6.

### Embodiment B7

The composition of Embodiment B6, wherein the polyamide-6,6 has a relative viscosity of 100 to 150 measured at 23° C. according to ASTM D789-07 in 90% formic acid, and an amine end group concentration of less than or equal to 100 microequivalents per gram.

### Embodiment B8

The composition of any of Embodiments B1-B7, wherein the poly(phenylene ether)-polysiloxane block copolymer comprises a poly(phenylene ether) block and a polysiloxane block, and wherein the composition comprises 0.2 to 2 weight percent of the polysiloxane block.

### Embodiment B9

The composition of any of Embodiments B1-B8, wherein the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof, wherein the poly(phenylene ether)-polysiloxane block copolymer comprises a polysiloxane block comprising repeating units having the structure

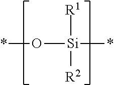

wherein each occurrence of R¹ and R² is independently hydrogen, C₁-C₁₂ hydrocarbyl, or C₁-C₁₂, halohydrocarbyl; and the polysiloxane block further comprises a terminal unit having the structure

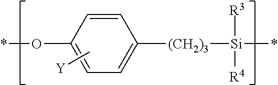

wherein Y is hydrogen, C₁-C₁₂, hydrocarbyl, C₁-C₁₂, hydrocarbyloxy, or halogen, and wherein each occurrence of R³ and R⁴ is independently hydrogen, C₁-C₁₂, hydrocarbyl, or C₁-C₁₂ halohydrocarbyl.

### Embodiment B10

The composition of any of Embodiments B1-B9, wherein the flame retardant further comprises melamine polyphosphate and zinc borate.

### Embodiment B11

The composition of Embodiment B10, wherein the flame retardant comprises, based on the total weight of the flame retardant, 50 to 76 weight percent of the metal dialkylphosphinate, 22 to 49 weight percent melamine polyphosphate, and 2 to 8 weight percent zinc borate.

### Embodiment B12

The composition of any of Embodiments B1-B11, wherein the surface-treated Boehmite has a particle diameter characterized by a D50 of 500 to 1500 nanometers.

### Embodiment B13

The composition of any of Embodiments B1-B12, wherein the surface-treated Boehmite has a particle diameter characterized by a D 10 of 200 to 600 nanometers, a D50 of 600 to 1200 nanometers, and a D90 of 1200 to 2600 nanometers.

### Embodiment B14

The composition of any of Embodiments B1-B13, wherein the surface-treated Boehmite is ACTILOX B60 AS1.

### Embodiment B15

The composition of any of Embodiments B1-B14, wherein the compatibilizing agent is selected from the group consisting of citric acid, fumaric acid, maleic acid, maleic anhydride, and combinations thereof.

### Embodiment B16

The composition of Embodiment 1, wherein the polyamide is polyamide-6,6; wherein the polyamide amount is 40 to 53 weight percent; wherein the poly(phenylene ether)-polysiloxane block copolymer reaction product amount is 9 to 13 weight percent; wherein the flame retardant amount is 7.3 to 12.8 weight percent, and the flame retardant comprises 5 to 8 weight percent of the metal dialkylphosphinate, 2 to 4 weight percent of melamine polyphosphate, and 0.3 to 0.8 weight percent of zinc borate; wherein the compatibilizing agent is selected from the group consisting of citric acid, fumaric acid, maleic acid, maleic anhydride, and combinations thereof; wherein the surface-treated Boehmite amount is 3 to 11 weight percent; and wherein the glass fibers amount is 20 to 30 weight percent.

### Embodiment B16a

A composition comprising the product of melt blending: 40 to 53 weight percent of a polyamide-6,6; 9 to 13 weight percent of a poly(phenylene ether)-polysiloxane block copolymer reaction product comprising a poly(phenylene ether) and a poly(phenylene ether)-polysiloxane block copolymer; 7.3 to 12.8 weight percent of a flame retardant comprising 5 to 8 weight percent of a metal dialkylphosphinate, 2 to 4 weight percent of melamine polyphosphate, and 0.3 to 0.8 weight percent of zinc borate; 0.2 to 2 weight percent of a compatibilizing agent selected from the group consisting of citric acid, fumaric acid, maleic acid, maleic anhydride, and combinations thereof; 3 to 11 weight percent of a surface-treated Boehmite; and 20 to 30 weight percent of glass fibers; wherein all weight percents are based on the total weight of the composition.

### Embodiment B17

The composition of Embodiment B16 or B16a, wherein the surface-treated Boehmite is ACTILOX B60 AS1.

### Embodiment B18

An article comprising a composition comprising the product of melt blending: 30 to 74.8 weight percent of a polyamide; 5 to 15 weight percent of a poly(phenylene ether)-polysiloxane block copolymer reaction product comprising a poly(phenylene ether) and a poly(phenylene ether)-polysiloxane block copolymer; 3 to 20 weight percent of a flame retardant comprising 3 to 9 weight percent of a metal dialkylphosphinate; 0.2 to 2 weight percent of a compatibilizing agent; 2 to 15 weight percent of a surface-treated Boehmite; and 15 to 45 weight percent of glass fibers; wherein all weight percents are based on the total weight of the composition.

### Embodiment B19

The article of Embodiment B18, wherein the article is a photovoltaic junction box or a photovoltaic junction connector.

### Embodiment B20

The article of Embodiment B18 or B19, wherein the polyamide is polyamide-6,6; wherein the polyamide amount is 40 to 53 weight percent; wherein the poly(phenylene ether)-polysiloxane block copolymer reaction product amount is 9 to 13 weight percent; wherein the flame retardant amount is 7.3 to 12.8 weight percent, and the flame retardant comprises 5 to 8 weight percent of the metal dialkylphosphinate, 2 to 4 weight percent of melamine polyphosphate, and 0.3 to 0.8 weight percent of zinc borate; wherein the compatibilizing agent is selected from the group consisting of citric acid, fumaric acid, maleic acid, maleic anhydride, and combinations thereof; wherein the surface-treated Boehmite amount is 3 to 11 weight percent; and wherein the glass fibers amount is 20 to 30 weight percent.

### Embodiment B20a

An article comprising a composition comprising the product of melt blending: 40 to 53 weight percent of a polyamide-6,6; 9 to 13 weight percent of a poly(phenylene ether)-polysiloxane block copolymer reaction product comprising a poly(phenylene ether) and a poly(phenylene ether)-polysiloxane block copolymer; 7.3 to 12.8 weight percent of a flame retardant comprising 5 to 8 weight percent of a metal dialkylphosphinate, 2 to 4 weight percent of melamine polyphosphate, and 0.3 to 0.8 weight percent of zinc borate; 0.2 to 2 weight percent of a compatibilizing agent selected from the group consisting of citric acid, fumaric acid, maleic acid, maleic anhydride, and combinations thereof; 3 to 11 weight percent of a surface-treated Boehmite; and 20 to 30 weight percent of glass fibers; wherein all weight percents are based on the total weight of the composition.

### Embodiment B21

The article of Embodiment B20 or B20a, wherein the article is a photovoltaic junction box or a photovoltaic junction connector.

The invention is further illustrated by the following non-limiting examples.

### Preparative Example 1

The poly(phenylene ether)-polysiloxane block copolymer reaction product used in the Examples was prepared as described for Example 16 in U.S. Pat. No. 8,017,697 to Carrillo et al.

Reaction conditions are summarized in Table 1, where “DMBA level (%)” is the concentration of dimethyl-n-butylamine, expressed as a weight percent relative to the weight of toluene; “Solids (%)” is the weight of total 2,6-dimethylphenol and eugenol-capped polysiloxane, expressed as a weight percent relative to the sum of the weights of 2,6-dimethylphenol, eugenol-capped polysiloxane, and toluene; “Polysiloxane chain length” is the average number of dimethylsiloxane (—Si(CH₃)₂O—) units in the eugenol-capped polysiloxane; “Polysiloxane loading (%)” is the weight percent of eugenol-capped polysiloxane in the reaction mixture, based on the total weight of the eugenol-capped polysiloxane and the 2,6-dimethylphenol; “Initial 2,6-dimethylphenol (%)” is the weight percent of 2,6-dimethylphenol present in the reaction vessel at the initiation of polymerization (the introduction of oxygen to the reaction vessel), relative to the total weight of 2,6-dimethylphenol; “O:2,6-dimethylphenol mole ratio” is the mole ratio of atomic oxygen (provided as molecular oxygen) to 2,6-dimethylphenol maintained during the addition of 2,6-dimethylphenol; “Temp., initial charge (° C.)” is the temperature, in degrees centigrade, of the reaction mixture when the initial charge of monomer was added to the reaction vessel, and when oxygen was first introduced to the reaction mixture; “Temp., addition (° C.)” is the reaction temperature during further addition of 2,6-dimethylphenol; “Temp., build (° C.)” is the temperature, expressed in degrees centigrade, during the build phase of the reaction; “Ramp time (min)” is the time, expressed in minutes, during which the temperature was ramped from the addition temperature to the build temperature; “Ramp slope (° C./min)” is the rate of change of temperature, expressed in degrees centigrade per minute, during the period in which the temperature was ramped from the addition temperature to the build temperature; “Reaction time (min)” is the total reaction time, expressed in minutes, elapsed between the moment of oxygen introduction and the moment of oxygen cut-off. Other than the monomer initially present in the reactor, monomer was added from 40 to 80 minutes relative to the start of reaction (that is, from the initiation of oxygen flow) at 0 minutes. Build time is measured from the end of controlled monomer addition to the end of reaction (that is, to the termination of oxygen flow). Build time was varied between 80 and 160 minutes.

The reactor and the 2,6-dimethylphenol addition tank were rinsed with warm toluene to assure their cleanliness. The reaction was purged with nitrogen to achieve an oxygen concentration of less than 1%. The reactor was charged with toluene, and this toluene was stirred at 500 rotations per minute (rpm). The temperature of the initial toluene was adjusted to the “initial charge” temperature of 21° C. and maintained at that temperature during addition of the initial charge of 2,6-dimethylphenol from the addition tank to the reaction vessel. After the addition of the initial charge of 2,6-dimethylphenol was complete, the reaction vessel was charged with the eugenol-capped polydimethylsiloxane, the di-n-butylamine, the dimethyl-n-butylamine, the diamine, and the copper catalyst. Oxygen flow and further monomer addition were initiated, and the oxygen flow was regulated to maintain a head space concentration less than 17 percent. During further monomer addition, cooling water supply temperature was adjusted to maintain the temperature specified as “Temp, addition (° C.)” in Table 1. After monomer addition was complete, the monomer addition line was flushed with toluene and the reaction temperature was increased to the temperature specified as “Temp, build (° C.)” in Table 1. This temperature adjustment was conducted over the time period specified as “Ramp time (min)”, and at the rate specified as “Ramp slope (° C./min)” in Table 1. The reaction was continued until a target intrinsic viscosity of 0.45 deciliter per gram was reached, then the oxygen flow was stopped. The reaction mixture was then heated to 60° C. and pumped to a chelation tank containing aqueous chelant solution. The resulting mixture was stirred and held at 60° C. for one hour. The light (organic) and heavy (aqueous) phases were separated by decantation, and the heavy phase was discarded. A small portion of the light phase was sampled and precipitated with isopropanol for analysis, and the remainder of the light phase was pumped to a precipitation tank and combined with methanol antisolvent in a weight ratio of 3 parts antisolvent to 1 part light phase. The precipitate was filtered to form a wet cake, which was reslurried three times with the same antisolvent and dried under nitrogen until a toluene concentration less than 1 weight percent was obtained.

For the product properties in Table 1, “Mol. Wt.<10K (%)” is the weight percent of the isolated product having a molecular weight less than 10,000 atomic mass units, as determined by gel permeation chromatography; “Mol. Wt.>100K (%)” is the weight percent of the isolated product having a molecular weight greater than 10,000 atomic mass units, as determined by gel permeation chromatography; “IV, end of rxn. (dL/g)” is the intrinsic viscosity, expressed in deciliters per gram and measured by Ubbelohde viscometer at 25° C. in chloroform, of dried powder isolated by precipitation from isopropanol; “IV, end of cheln. (dL/g)” expressed in deciliters per gram and measured by Ubbelohde viscometer at 25° C. in chloroform, of the product present in the post-chelation organic phase which has been isolated by precipitation from isopropanol then dried; “M_{w}, end of rxn. (AMU)” is the weight average molecular weight, expressed in atomic mass units and measured by gel permeation chromatography, of the product present in the reaction mixture at the end of the polymerization reaction which has been isolated by precipitation from isopropanol then dried; “Mₙ, end of rxn. (AMU)” is the number average molecular weight, expressed in atomic mass units and measured by gel permeation chromatography, of the product present in the reaction mixture at the end of the polymerization reaction which has been isolated by precipitation from isopropanol then dried; “M_{w}/Mₙ, end of rxn.” is the ratio of weight average molecular weight to number average molecular weight for the product present in the reaction mixture at the end of the polymerization reaction which has been isolated by precipitation from isopropanol then dried; “M_{w}, end of cheln. (AMU)” is the weight average molecular weight, expressed in atomic mass units and measured by gel permeation chromatography, of the product present in the post-chelation organic phase which has been isolated by precipitation from isopropanol then dried; “Mₙ, end of cheln. (AMU)” is the number average molecular weight, expressed in atomic mass units and measured by gel permeation chromatography, of the product present in the post-chelation organic phase which has been isolated by precipitation from isopropanol then dried; “M_{w}/Mₙ, end of cheln.” is the ratio of weight average molecular weight to number average molecular weight for the product present in the post-chelation organic phase which has been isolated by precipitation from isopropanol then dried; “Weight % siloxane (%)” is the weight percent of dimethylsiloxane units in the isolated product, based on the total weight of 2,6-dimethyl-1,4-phenylene ether units and dimethylsiloxane units in the isolated product., as determined by ¹H NMR; “Siloxane Incorporation Efficiency (%)” is the weight percent of dimethylsiloxane units in the isolated product compared to the weight percent of dimethylsiloxane units in the total monomer composition, as determined by ¹H NMR; “Weight % Biphenyl (%)” is the weight percent of 3,3′,5,5′-tetramethyl-4,4′-biphenol residues in the isolated product, as determined by ¹H NMR. Details of ¹H NMR methods can be found in U.S. Pat. No. 8,017,697.

TABLE 1

P. Ex. 1

REACTION CONDITIONS

| | |
|---|---|
| DMBA level (%) | 1.2 |
| Solids (%) | 23 |
| Polysiloxane chain length | 45 |
| Polysiloxane loading (%) | 5 |
| Initial 2,6-DMP (%) | 7.9 |
| O:2,6-dimethylphenol mole ratio | 0.98 |
| Catalyst (%) | 0.75 |
| Temp., initial charge (° C.) | 21 |
| Temp., addition (° C.) | 38 |
| Temp., build (° C.) | 49 |
| Ramp time (min) | 30 |
| Ramp slope (° C./min) | 0.37 |
| Reaction time (min) | 200 |

FINAL PRODUCT PROPERTIES

| | |
|---|---|
| Mol. Wt. <10K (%) | 11 |
| Mol. Wt. >100K (%) | 16 |
| IV, end of rxn. (dL/g) | 0.45 |
| IV, end of cheln. (dL/g) | 0.39 |
| M_{w}, end of rxn. (AMU) | 64000 |
| Mₙ, end of rxn. (AMU) | 23000 |
| M_{w}/Mₙ, end of rxn. | 2.8 |
| M_{w}, end of cheln. (AMU) | 56000 |
| Mₙ, end of cheln. (AMU) | 20000 |
| M_{w}/Mₙ, end of cheln. | 2.7 |
| Weight % siloxane (%) | 4.78 |
| Silox. Incorp. Effic. (%) | 96 |
| Weight % Biphenyl (%) | 1.26 |

### Examples 1-6, Comparative Examples 1-6

These examples illustrate the effect of poly(phenylene ether)-polysiloxane block copolymer reaction product relative to poly(phenylene ether) at various concentrations, and the effect of presence versus absence of compatibilizing agent.

Components used to form the compositions are summarized in Table 2.

TABLE 2

| Component | Description |
|---|---|
| PA-6,6 pellets | Polyamide-6,6, CAS Reg. No. 32131-17-2, having a relative viscosity |
| | of about 126 measured in 90% formic acid according to ASTM D789, |
| | and an amine end group concentration of about 51 microequivalents |
| | per gram; obtained in pellet form as STABAMID ™ 24FE1 from |
| | Rhodia. |
| PA-6,6 powder | Polyamide-6,6, CAS Reg. No. 32131-17-2, having a relative viscosity |
| | of about 126 measured in 90% formic acid according to ASTM D789, |
| | and an amine end group concentration of about 51 microequivalents |
| | per gram; obtained in pellet form as STABAMID ™ 24FE1 from |
| | Rhodia and milled to a powder. |
| PPE | Poly(2,6-dimethyl-1,4-phenylene ether), CAS Reg. No. 24938-67-8, |
| | having an intrinsic viscosity of about 0.40 deciliter per gram as |
| | measured in chloroform at 25° C.; obtained as PPO ™ 640 from SABIC |
| | Innovative Plastics. |
| PPE-Si | Poly(phenylene ether)-polysiloxane block copolymer reaction |
| | product, prepared as described in Preparative Example 1 and having |
| | an intrinsic viscosity of about 0.4 deciliter/gram as measured in |
| | chloroform at 25° C. |
| OP1312 | A flame retardant mixture of about 63 weight percent aluminum |
| | tris(diethylphosphinate), about 32 weight percent melamine |
| | polyphosphate, and about 5 weight percent zinc borate; obtained as |
| | EXOLIT ™ OP 1312 from Clariant. |
| Al stearate | Aluminum stearate, CAS Reg. No. 97404-28-9; obtained from Sogis |
| | Industria Chimica S.A. |
| PETS | Pentaerythritol tetrastearate, CAS Reg. No. 115-83-3; obtained from |
| | FACI SpA. |
| Phenol AO | N,N′-Hexamethylene bis[3-(3,5-di-t-butyl- |
| | 4-hydroxyphenyl)propionamide]; obtained as IRGANOX ™ 1098 |
| | from Ciba. |
| Phosphite | Tris(di-t-butylphenyl)phosphite, CAS Reg. No. 31570-04-4; obtained |
| | as IRGAFOS ™ 168 from Ciba. |
| Citric acid | Citric acid, CAS Reg. No. 77-92-9; obtained from Jungbunzlauer. |
| Carbon black | Carbon black pigment having an iodine number of about 121 |
| | milligrams/gram as measured according to ASTM D1510; obtained in |
| | pellet form as ELFTEX 570 from Cabot. |
| AlOOH | Aluminum oxide hydroxide (Boehmite, not surface-treated) having a |
| | particle size D10 of about 400 nanometers, D50 of about 900 |
| | nanometers, and D90 of about 1,700 nanometers; obtained as |
| | ACTILOX B 60 AS from Nabaltech. |
| ST AlOOH | Surface-treated aluminum oxide hydroxide (surface-treated Boehmite) |
| | having a particle size D10 of about 400 nanometers, D50 of about 900 |
| | nanometers, and D90 of about 1,700 nanometers; obtained as |
| | ACTILOX B 60 AS1 from Nabaltech. |
| Glass fiber | Chopped glass fiber having a diameter of about 10 micrometers, |
| | surface-treated with a silane sizing for compatibility with polyamide; |
| | obtained as CHOPVANTAGE ™ HP 3660 from PPG. |

Compounding was conducted on a 28 millimeter internal diameter ZSK twin-screw extruder at a melt temperature of 250 to 270° C. and a throughput of 15 kilograms/hour. All ingredients in powder form (PA-6,6 powder, PPE-S1, OP1312, Phenol AO, Phosphite, Citric acid, Carbon black, AlOOH, and ST AlOOH) were combined by hand shaking in bags and were introduced at the throat of the extruder in the first feeder. Polyamide-6,6 pellets were fed via a second feeder, also at the throat of the extruder. Glass fibers were added further downstream in the extruder. The extrudate was pelletized, and pellets were conditioned for 5.5 hours at 120° C. under vacuum before use for melt viscosity testing or injection molding samples for physical property testing.

Melt viscosity testing was performed according to ISO 11443:2005, using a temperature of 282° C. and the multi-point method where melt viscosity at various shear rates was measured. In Table 3, melt viscosity values having units of Pascal-seconds were measured at a shear rate of 1,500 second⁻¹.

For physical property testing, compositions were injection molded into test samples using an injection molding machine operating at a melt temperature of 250 to 290° C. and a mold temperature of 80 to 100° C. Test samples were conditioned for 48 hours at 23° C. before testing.

Flexural modulus and flexural strength values, expressed in units of megapascals, were determined at 23° C. according to ISO 178:2010 using bar cross-sectional dimensions of 80 millimeters by 10 millimeters by 4 millimeters, a support span of 64 millimeters, and three specimens per composition.

Tensile modulus and tensile stress at break values, both expressed in units of megapascals, and nominal tensile strain at break values, expressed in units of percent, were determined at 23° C. according to ISO 527-1:2012 using a Type 1A bar having dimensions of 80 millimeters by 10 millimeters by 4 millimeters, a gage length of 50 millimeters, a grip separation of 115 millimeters, a test speed of 1 millimeter/minute, and five samples per composition.

Izod notched and unnotched impact values, expressed in units of kilojoules/meter², were determined at 23° C. according to ISO 180:2000 using a Type A radius and a notch angle of 45 degrees and an 8 millimeter depth of material under the notch for notched samples, a hammer energy of 2.75 joules, bar cross-sectional dimensions of 10 millimeters by 4 millimeters, and ten samples per composition.

Vicat softening temperature was measured according to ISO 306:2004 using Method B 120, a needle penetration of 1 millimeter at reading, a pre-loading time of 5 minutes, and three specimens per composition.

Comparative Tracking Index (CTI) values, express in units of volts, were determine according to the International Electrotechnical Commission (IEC) standard IEC-60112, Third edition (1979) using test samples having a thickness of 3.2 millimeters and diameter of 10 centimeters, and five samples per composition. The reported value is the voltage that causes tracking after 50 drops of ammonium chloride solution have fallen on the material surface.

Flame retardancy of injection molded flame bars was determined according to Underwriter's Laboratory Bulletin 94 “Tests for Flammability of Plastic Materials, UL 94”, 20 mm Vertical Burning Flame Test. Before testing, flame bars with a thickness of 0.8 millimeters were conditioned at 23° C. and 50% relative humidity for at least 48 hours. In the UL 94 20 mm Vertical Burning Flame Test, a set of five flame bars is tested. For each bar, a flame is applied to the bar then removed, and the time required for the bar to self-extinguish (first afterflame time, t1) is noted. The flame is then reapplied and removed, and the time required for the bar to self-extinguish (second afterflame time, t2) and the post-flame glowing time (afterglow time, t3) are noted. To achieve a rating of V-0, the afterflame times t1 and t2 for each individual specimen must be less than or equal to 10 seconds; and the total afterflame time for all five specimens (t1 plus t2 for all five specimens) must be less than or equal to 50 seconds; and the second afterflame time plus the afterglow time for each individual specimen (t2+t3) must be less than or equal to 30 seconds; and no specimen can flame or glow up to the holding clamp; and the cotton indicator cannot be ignited by flaming particles or drops. To achieve a rating of V-1, the afterflame times t1 and t2 for each individual specimen must be less than or equal to 30 seconds; and the total afterflame time for all five specimens (t1 plus t2 for all five specimens) must be less than or equal to 250 seconds; and the second afterflame time plus the afterglow time for each individual specimen (t2+t3) must be less than or equal to 60 seconds; and no specimen can flame or glow up to the holding clamp; and the cotton indicator cannot be ignited by flaming particles or drops. To achieve a rating of V-2, the afterflame times t1 and t2 for each individual specimen must be less than or equal to 30 seconds; and the total afterflame time for all five specimens (t1 plus t2 for all five specimens) must be less than or equal to 250 seconds; and the second afterflame time plus the afterglow time for each individual specimen (t2+t3) must be less than or equal to 60 seconds; and no specimen can flame or glow up to the holding clamp; but the cotton indicator can be ignited by flaming particles or drops. Compositions not meeting the V-2 criteria are considered to have failed.

Compositions and property results are summarized in Table 3. The results show that Examples 1-5 with poly(phenylene ether)-polysiloxane block copolymer reaction product exhibit higher Comparative Tracking Index values than do respective Comparative Examples 1-5 with poly(phenylene ether). Examples 1-5 with poly(phenylene ether)-polysiloxane block copolymer reaction product also maintained the desirable V-0 flammability rating.

TABLE 3

| | | | | | |
|---|---|---|---|---|---|
| C. Ex. 1 | Ex. 1 | C. Ex. 2 | Ex. 2 | C. Ex. 3 | Ex. 3 |

COMPOSITIONS

| | | | | | | |
|---|---|---|---|---|---|---|
| PA-6,6 pellets | 45.2 | 45.2 | 42.2 | 42.2 | 37.2 | 37.2 |
| PPE | 2 | 0 | 5 | 0 | 10 | 0 |
| PPE-Si | 0 | 2 | 0 | 5 | 0 | 10 |
| OP1312 | 21 | 21 | 21 | 21 | 21 | 21 |
| Al stearate | 0.25 | 0.25 | 0.25 | 0.25 | 0.25 | 0.25 |
| Phenol AO | 0.2 | 0.2 | 0.2 | 0.2 | 0.2 | 0.2 |
| Phosphite | 0.15 | 0.15 | 0.15 | 0.15 | 0.15 | 0.15 |
| PA-6,6 powder | 5 | 5 | 5 | 5 | 5 | 5 |
| Citric acid | 0.7 | 0.7 | 0.7 | 0.7 | 0.7 | 0.7 |
| Glass fiber | 25.5 | 25.5 | 25.5 | 25.5 | 25.5 | 25.5 |

PROPERTIES

| | | | | | | |
|---|---|---|---|---|---|---|
| Melt viscosity (Pa-s) | 90.89 | 92.06 | 100.67 | 103.53 | 106.83 | 103.01 |
| Tensile modulus (MPa) | 10060.6 | 9869.8 | 9805.0 | 9971.2 | 9949.6 | 9806.2 |
| Tensile stress at break (MPa) | 148.35 | 136.15 | 137.16 | 134.10 | 141.20 | 127.66 |
| Nominal tensile strain at break (%) | 3.02 | 2.64 | 27.6 | 2.64 | 2.80 | 2.58 |
| Notched Izod (kJ/m²) | 8.59 | 7.94 | 8.23 | 7.83 | 8.31 | 7.43 |
| Unnotched Izod (kJ/m²) | 43.23 | 41.43 | 40.33 | 40.44 | 38.90 | 34.50 |
| Vicat temp. (° C.) | 247.15 | 245.30 | 245.25 | 244.80 | 243.60 | 239.25 |
| UL 94 rating, 0.8 mm | V-0 | V-0 | V-0 | V-0 | V-0 | V-0 |
| CTI (V) | 575 | 600 | 500 | 525 | 450 | 475 |

| | | | | | |
|---|---|---|---|---|---|
| C. Ex. 4 | Ex. 4 | C. Ex. 5 | Ex. 5 | C. Ex. 6 | Ex. 6 |

COMPOSITIONS

| | | | | | | |
|---|---|---|---|---|---|---|
| PA-6,6 pellets | 45.9 | 45.9 | 42.9 | 42.9 | 37.9 | 37.9 |
| PPE | 2 | 0 | 5 | 0 | 10 | 0 |
| PPE-Si | 0 | 2 | 0 | 5 | 0 | 10 |
| OP1312 | 21 | 21 | 21 | 21 | 21 | 21 |
| Al stearate | 0.25 | 0.25 | 0.25 | 0.25 | 0.25 | 0.25 |
| Phenol AO | 0.2 | 0.2 | 0.2 | 0.2 | 0.2 | 0.2 |
| Phosphite | 0.15 | 0.15 | 0.15 | 0.15 | 0.15 | 0.15 |
| PA-6,6 powder | 5 | 5 | 5 | 5 | 5 | 5 |
| Citric acid | 0 | 0 | 0 | 0 | 0 | 0 |
| Glass fiber | 25.5 | 25.5 | 25.5 | 25.5 | 25.5 | 25.5 |

PROPERTIES

| | | | | | | |
|---|---|---|---|---|---|---|
| Melt viscosity (Pa-s) | 111.63 | 127.64 | 104.68 | 139.48 | 140.3 | 143.76 |
| Tensile modulus (MPa) | 9856.8 | 10174.8 | 10028.6 | 9945.6 | 9800 | 9826.6 |
| Tensile stress at break (MPa) | 148.73 | 146.13 | 142.93 | 140.11 | 135.5 | 133.19 |
| Nominal tensile strain at break (%) | 3.16 | 3.02 | 2.96 | 2.94 | 2.8 | 2.78 |
| Notched Izod (kJ/m²) | 8.47 | 8.51 | 8.27 | 8.23 | 7.4 | 7.79 |
| Unnotched Izod (kJ/m²) | 46.89 | 48.66 | 46.39 | 45.68 | — | 40.51 |
| Vicat temp. (° C.) | 247.95 | 249.50 | 247.75 | 248.20 | 242.2 | 243.10 |
| UL 94 rating, 0.8 mm | V-0 | V-0 | V-0 | V-0 | V-0 | V-0 |
| CTI (V) | 500 | 600 | 525 | 575 | 500 | 525 |

### Example 7

This example illustrates another composition according to the invention. It is surprising that a CTI value of 525 volts and a UL 94 rating of V-0 were maintained at 10% poly(phenylene ether)-polysiloxane block copolymer reaction product, even as the flame retardant content was decreased from 21% to 15% (compare Example 7 and Example 6).

TABLE 4

Ex. 7

COMPOSITION

| | |
|---|---|
| PA-6,6 pellets | 43.20 |
| PPE-Si | 10.00 |
| OP1312 | 15.00 |
| PETS | 0.25 |
| Phenol AO | 0.20 |
| Phosphite | 0.15 |
| PA-6,6 powder | 5.00 |
| Citric acid | 0.70 |
| Glass fiber | 25.50 |

PROPERTIES

| | |
|---|---|
| Melt viscosity (Pa-s) | 65.4 |
| Tensile modulus (MPa) | 9950 |
| Tensile stress at break (MPa) | 140 |
| Nominal tensile strain at break (%) | 3.1 |
| Notched Izod (kJ/m²) | 7.4 |
| Unnotched Izod (kJ/m²) | 36.3 |
| Vicat temp. (° C.) | 245.1 |
| UL 94 rating, 0.8 mm | V-0 |
| CTI (V) | 525 |

### Examples 8-11, Comparative Examples 7 and 8

These examples further demonstrate the high flame retardancy and electrical resistivity provided by the inventive composition. Examples 9-11 also demonstrate that the use of surface-treated Boehmite permits a reduction in flame retardant content while maintaining a V-0 flammability rating and high Comparative Tracking Index values.

TABLE 5

| | | | | | |
|---|---|---|---|---|---|
| Ex. 8 | C. Ex. 7 | C. Ex. 8 | Ex. 9 | Ex. 10 | Ex. 11 |

COMPOSITIONS

| | | | | | | |
|---|---|---|---|---|---|---|
| PA-6,6 pellets | 43.2 | 43.2 | 43.2 | 37.9 | 35.9 | 43.2 |
| PPE-Si | 10.0 | 10.0 | 10.0 | 10.0 | 10.0 | 10.0 |
| OP1312 | 15.0 | 10.0 | 5.0 | 15.0 | 12.0 | 10.0 |
| Al stearate | 0.25 | 0.25 | 0.25 | 0.25 | 0.25 | 0.25 |
| Phenol AO | 0.2 | 0.2 | 0.2 | 0.2 | 0.2 | 0.2 |
| Phosphite | 0.15 | 0.15 | 0.15 | 0.15 | 0.15 | 0.15 |
| PA-6,6 powder | 5.0 | 5.0 | 5.0 | 5.0 | 5.0 | 5.0 |
| Citric acid | 0.7 | 0.7 | 0.7 | 0.7 | 0.7 | 0.7 |
| Carbon black | 0.3 | 0.3 | 0.3 | 0.3 | 0.3 | 0.3 |
| AlOOH | 0.0 | 5.0 | 10.0 | 0.0 | 0.0 | 0.0 |
| ST AlOOH | 0.0 | 0.0 | 0.0 | 5.0 | 10.0 | 5.0 |
| Glass fiber | 25.5 | 25.5 | 25.5 | 25.5 | 25.5 | 25.5 |

PROPERTIES

| | | | | | | |
|---|---|---|---|---|---|---|
| Melt viscosity (Pa-s) | 132 | 124 | 111 | 162 | 149 | 129 |
| Tensile modulus (MPa) | 9700 | 9600 | 9800 | 10100 | 10300 | 9800 |
| Flexural modulus (MPa) | 8100 | 8000 | 8200 | 8700 | 8800 | 8200 |
| Flexural strength (MPa) | 182 | 170 | 174 | 169 | 167 | 175 |
| Notched Izod (kJ/m²) | 7 | 5 | 4 | 5.5 | 5 | 5 |
| Unnotched Izod (kJ/m²) | 34 | 25 | 24 | 26 | 24 | 28 |
| Vicat temp. (° C.) | 245 | 245 | 246 | 244 | 245 | 242 |
| UL 94 rating, 0.8 mm | V-0 | V-2 | V-2 | V-0 | V-0 | V-0 |
| CTI (V) | 500 | 550 | 575 | 500 | 575 | 550 |

1. A composition comprising the product of melt blending:
30 to 89 weight percent of a polyamide;
1 to 15 weight percent of a poly(phenylene ether)-polysiloxane block copolymer reaction product comprising a poly(phenylene ether) and a poly(phenylene ether)-polysiloxane block copolymer;
5 to 25 weight percent of a flame retardant comprising
4 to 16 weight percent of a metal dialkylphosphinate,
0.9 to 8 weight percent of melamine polyphosphate, and
0.1 to 3 weight percent of zinc borate;
5 to 45 weight percent of glass fibers; and
0 to 15 weight percent of a surface-treated Boehmite;
wherein the composition comprises 5 to 20 weight percent of the flame retardant when the composition comprises 5 to 15 weight percent of the surface-treated Boehmite;
wherein the composition comprises greater than 10 to 25 weight percent of the flame retardant when the composition comprises 0 to less than 5 weight percent of the surface-treated Boehmite; and
wherein all weight percents are based on the total weight of the composition.

2. The composition of claim 1, exhibiting a comparative tracking index of at least 475 volts measured according to IEC-60112, Third edition, and
a 20 millimeter Vertical Burning Test rating of V-0 measured according to Underwriters Laboratory UL 94 “Tests for Flammability of Plastic Materials for Parts in Devices and Appliances”.

3. The composition of claim 2, exhibiting a comparative tracking index of 475 to 600 volts.

4. The composition of claim 1, wherein the polyamide comprises polyamide-6,6.

5. The composition of claim 1, wherein the poly(phenylene ether)-polysiloxane block copolymer comprises a poly(phenylene ether) block and a polysiloxane block, and wherein the composition comprises 0.2 to 2 weight percent of the polysiloxane block.

6. The composition of claim 1,
wherein the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof; and
wherein the poly(phenylene ether)-polysiloxane block copolymer comprises a polysiloxane block comprising repeating units having the structure 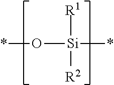
wherein each occurrence of R¹ and R² is independently hydrogen, C₁-C₁₂ hydrocarbyl, or C₁-C₁₂ halohydrocarbyl; and the polysiloxane block further comprises a terminal unit having the structure 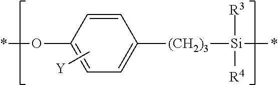
wherein Y is hydrogen, C₁-C₁₂ hydrocarbyl, C₁-C₁₂ hydrocarbyloxy, or halogen, and wherein each occurrence of R³ and R⁴ is independently hydrogen, C₁-C₁₂ hydrocarbyl, or C₁-C₁₂ halohydrocarbyl.

7. The composition of claim 1, wherein the flame retardant comprises, based on the total weight of the flame retardant, 50 to 76 weight percent of the metal dialkylphosphinate, 22 to 49 weight percent of the melamine polyphosphate, and 2 to 8 weight percent of the zinc borate.

8. The composition of claim 1,
wherein the polyamide comprises polyamide-6,6;
wherein the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof, wherein the poly(phenylene ether)-polysiloxane block copolymer comprises a polysiloxane block comprising repeating units having the structure 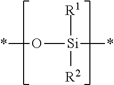
wherein each occurrence of R¹ and R² is independently hydrogen, C₁-C₁₂ hydrocarbyl, or C₁-C₁₂ halohydrocarbyl; and the polysiloxane block further comprises a terminal unit having the structure 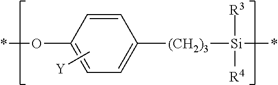
wherein Y is hydrogen, C₁-C₁₂, hydrocarbyl, C₁-C₁₂, hydrocarbyloxy, or halogen, and wherein each occurrence of R³ and R⁴ is independently hydrogen, C₁-C₁₂ hydrocarbyl, or C₁-C₁₂ halohydrocarbyl;
wherein the composition comprises
44 to 52 weight percent of the polyamide,
8 to 12 weight percent of the poly(phenylene ether)-polysiloxane block copolymer reaction product,
12 to 18 weight percent of the flame retardant comprising
7 to 12 weight percent of aluminum tris(diethylphosphinate),
3 to 7 weight percent of melamine polyphosphate, and
0.4 to 1.5 weight percent of zinc borate, and
20 to 30 weight percent of the glass fibers; and
wherein the composition further comprises 0.2 to 2 weight percent of a compatibilizing agent selected from the group consisting of citric acid, fumaric acid, maleic acid, maleic anhydride, and combinations thereof.

9. The composition of claim 1,
wherein the composition comprises 30 to 74.8 weight percent of the polyamide;
wherein the composition comprises 5 to 15 weight percent of the poly(phenylene ether)-polysiloxane block copolymer reaction product;
wherein the composition comprises 3 to 20 weight percent of the flame retardant;
wherein the composition comprises 2 to 15 weight percent of the surface-treated Boehmite;
and wherein the composition further comprises 0.2 to 2 weight percent of a compatibilizing agent.

10. The composition of claim 9, wherein the surface-treated Boehmite has a particle diameter characterized by a D10 of 200 to 600 nanometers, a D50 of 600 to 1200 nanometers, and a D90 of 1200 to 2600 nanometers.

11. The composition of claim 9,
wherein the polyamide comprises polyamide-6,6;
wherein the compatibilizing agent is selected from the group consisting of citric acid, fumaric acid, maleic acid, maleic anhydride, and combinations thereof; and
wherein the composition comprises
40 to 53 weight percent of the polyamide,
9 to 13 weight percent of the poly(phenylene ether)-polysiloxane block copolymer reaction product,
7.3 to 12.8 weight percent of the flame retardant comprising
5 to 8 weight percent of the metal dialkylphosphinate,
2 to 4 weight percent of the melamine polyphosphate, and
0.3 to 0.8 weight percent of the zinc borate,
3 to 11 weight percent of the surface-treated Boehmite, and
20 to 30 weight percent of the glass fibers.

12. An article comprising the composition of claim 1.

13. The article of claim 12,
wherein the polyamide comprises polyamide-6,6;
wherein the poly(phenylene ether)-polysiloxane block copolymer comprises a poly(phenylene ether) block comprising 2,6-dimethyl-1,4-phenylene ether repeating units, 2,3,6-trimethyl-1,4-phenylene ether repeating units, or a combination thereof, wherein the poly(phenylene ether)-polysiloxane block copolymer comprises a polysiloxane block comprising repeating units having the structure 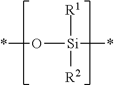
wherein each occurrence of R¹ and R² is independently hydrogen, C₁-C₁₂ hydrocarbyl, or C₁-C₁₂, halohydrocarbyl; and the polysiloxane block further comprises a terminal unit having the structure 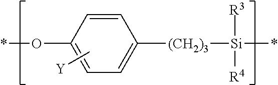
wherein Y is hydrogen, C₁-C₁₂ hydrocarbyl, C₁-C₁₂ hydrocarbyloxy, or halogen, and wherein each occurrence of R³ and R⁴ is independently hydrogen, C₁-C₁₂, hydrocarbyl, or C₁-C₁₂ halohydrocarbyl;
wherein the composition comprises
44 to 52 weight percent of the polyamide,
8 to 12 weight percent of the poly(phenylene ether)-polysiloxane block copolymer reaction product,
12 to 18 weight percent of the flame retardant comprising
7 to 12 weight percent of aluminum tris(diethylphosphinate),
3 to 7 weight percent of melamine polyphosphate, and
0.4 to 1.5 weight percent of zinc borate, and
20 to 30 weight percent of the glass fibers; and
wherein the composition further comprises 0.2 to 2 weight percent of a compatibilizing agent selected from the group consisting of citric acid, fumaric acid, maleic acid, maleic anhydride, and combinations thereof.

14. The article of claim 12, wherein the article is or is part of a photovoltaic junction box, a photovoltaic junction connector, an inverter housing, an electrical connector, an electrical relay, or a charge coupler.

15. The article of claim 12,
wherein the composition comprises 30 to 74.8 weight percent of the polyamide;
wherein the composition comprises 5 to 15 weight percent of the poly(phenylene ether)-polysiloxane block copolymer reaction product;
wherein the composition comprises 3 to 20 weight percent of the flame retardant;
wherein the composition comprises 2 to 15 weight percent of the surface-treated Boehmite;
and wherein the composition further comprises 0.2 to 2 weight percent of a compatibilizing agent.

16. The article of claim 15,
wherein the polyamide comprises polyamide-6,6;
wherein the compatibilizing agent is selected from the group consisting of citric acid, fumaric acid, maleic acid, maleic anhydride, and combinations thereof; and
wherein the composition comprises
40 to 53 weight percent of the polyamide,
9 to 13 weight percent of the poly(phenylene ether)-polysiloxane block copolymer reaction product,
7.3 to 12.8 weight percent of the flame retardant comprising
5 to 8 weight percent of the metal dialkylphosphinate,
2 to 4 weight percent of the melamine polyphosphate, and
0.3 to 0.8 weight percent of the zinc borate,
3 to 11 weight percent of the surface-treated Boehmite, and
20 to 30 weight percent of the glass fibers.

17. The article of claim 15, wherein the article is or is part of a photovoltaic junction box, a photovoltaic junction connector, an inverter housing, an electrical connector, an electrical relay, or a charge coupler.
